(19) United States
(12) Patent Application Publication
(10) Pub. No.: US 2022/0084188 A1
(43) Pub. Date: Mar. 17, 2022

(54) IMAGE PROCESSING APPARATUS, IMAGE PROCESSING METHOD, INSPECTION APPARATUS, AND NON-TRANSITORY COMPUTER READABLE RECORDING MEDIUM

(71) Applicant: SCREEN HOLDINGS CO., LTD., Kyoto (JP)

(72) Inventor: Hiroyuki Onishi, Kyoto (JP)

(21) Appl. No.: 17/459,720

(22) Filed: Aug. 27, 2021

(30) Foreign Application Priority Data
Sep. 14, 2020 (JP) 2020-154005

(51) Int. Cl. G06T 7/00; G06T 17/00; G06K 9/00; G06K 9/20; G06T 11/00

(52) U.S. Cl. CPC G06T 7/0002; G06T 17/00; G06T 2207/20092; G06K 9/2054; G06T 11/00; G06K 9/00214

(57) ABSTRACT

A first acquisition unit acquires three-dimensional model information related to a three-dimensional model of an inspection object and inspection region information related to an inspection region in the three-dimensional model. A second acquisition unit acquires position attitude information regarding a position and an attitude of an imaging unit and the inspection object in an inspection apparatus. A designation unit creates region designation information for designating an inspection image region corresponding to the inspection region for a captured image that can be acquired by imaging of the inspection object by the imaging unit based on the three-dimensional model information, the inspection region information, and the position attitude information.

### BACKGROUND OF THE INVENTION

### Field of the Invention

The present invention relates to an image processing apparatus, an image processing method, an inspection apparatus, and a non-transitory computer readable recording medium.

### Description of the Background Art

Conventionally, for an inspection object such as a component having a three-dimensional shape, a defect has been found by visual inspection in which a person looks at the inspection object from various angles. However, an inspection apparatus that automatically inspects the inspection object for the purpose of reducing personnel and securing a quality level is considered.

In such an inspection apparatus, for example, a region (also referred to as an inspection image region) in which a portion to be inspected in the inspection object is captured can be designated by the user on the captured image displayed on the screen (For example, Japanese Patent Application Laid-Open No. 2015-21764).

### SUMMARY OF THE INVENTION

The present invention is directed to an image processing apparatus.

According to one aspect of the present invention, an image processing apparatus includes: a first acquisition unit configured to acquire three-dimensional model information related to a three-dimensional model of an inspection object and inspection region information related to an inspection region in the three-dimensional model; a second acquisition unit configured to acquire position attitude information regarding a position and an attitude of an imaging unit and the inspection object in an inspection apparatus; and a designation unit configured to create region designation information for designating an inspection image region corresponding to the inspection region for a captured image that can be acquired by imaging of the inspection object by the imaging unit, based on the three-dimensional model information, the inspection region information, and the position attitude information.

For example, region designation information for designating an image region corresponding to the inspection region for the captured image that can be acquired by the imaging of the inspection object by the imaging unit can be created based on the information related to the three-dimensional model of the inspection object, the information related to the inspection region in the three-dimensional model, and the information related to the position and attitude of the imaging unit and the inspection object in the inspection apparatus. Thus, for example, the inspection image region can be efficiently designated for the captured image related to the inspection object.

The present invention is also directed to an inspection apparatus that inspects an inspection object having a three-dimensional shape.

According to one aspect of the present invention, an inspection apparatus includes: a holding unit configured to hold the inspection object; an imaging unit configured to image the inspection object held by the holding unit; and an image processing unit. The image processing unit includes: a first acquisition unit configured to acquire three-dimensional model information related to a three-dimensional model of the inspection object and inspection region information related to an inspection region in the three-dimensional model; a second acquisition unit configured to acquire position attitude information regarding a position and an attitude of the imaging unit and the inspection object held by the holding unit; and a designation unit configured to create region designation information for designating an inspection image region corresponding to the inspection region for a captured image that can be acquired by imaging of the inspection object by the imaging unit, based on the three-dimensional model information, the inspection region information, and the position attitude information.

For example, region designation information for designating an image region corresponding to the inspection region for the captured image that can be acquired by the imaging of the inspection object by the imaging unit can be created based on the information related to the three-dimensional model of the inspection object, the information related to the inspection region in the three-dimensional model, and the information related to the position and attitude of the imaging unit and the inspection object in the inspection apparatus. Thus, for example, the inspection image region can be efficiently designated for the captured image related to the inspection object.

The present invention is also directed to an image processing method.

According to one aspect of the present invention, an image processing method includes the steps of: (a) acquiring three-dimensional model information related to a three-dimensional model of an inspection object and inspection region information related to an inspection region in the three-dimensional model by a first acquisition unit; (b) acquiring position attitude information regarding a position and an attitude of an imaging unit and the inspection object in an inspection apparatus by a second acquisition unit; and (c) creating region designation information for designating an inspection image region corresponding to the inspection region for a captured image that can be acquired by imaging of the inspection object by the imaging unit, based on the three-dimensional model information, the inspection region information, and the position attitude information by a designation unit.

For example, region designation information for designating an image region corresponding to the inspection region for the captured image that can be acquired by the imaging of the inspection object by the imaging unit can be created based on the information related to the three-dimensional model of the inspection object, the information related to the inspection region in the three-dimensional model, and the information related to the position and attitude of the imaging unit and the inspection object in the inspection apparatus. Thus, for example, the inspection image region can be efficiently designated for the captured image related to the inspection object.

The present invention is also directed to a non-transitory computer readable recording medium.

According to one aspect of the present invention, a non-transitory computer readable recording medium is a non-transitory computer readable recording medium storing a program, the program causing a processor of a control unit in an information processing apparatus to execute: (a) acquiring three-dimensional model information related to a three-dimensional model of an inspection object and inspection region information related to an inspection region in the three-dimensional model by a first acquisition unit; (b) acquiring position attitude information regarding a position and an attitude of an imaging unit and the inspection object in an inspection apparatus by a second acquisition unit; and (c) creating region designation information for designating an inspection image region corresponding to the inspection region for a captured image that can be acquired by imaging of the inspection object by the imaging unit, based on the three-dimensional model information, the inspection region information, and the position attitude information by a designation unit.

For example, region designation information for designating an image region corresponding to the inspection region for the captured image that can be acquired by the imaging of the inspection object by the imaging unit can be created based on the information related to the three-dimensional model of the inspection object, the information related to the inspection region in the three-dimensional model, and the information related to the position and attitude of the imaging unit and the inspection object in the inspection apparatus. Thus, for example, the inspection image region can be efficiently designated for the captured image related to the inspection object.

Therefore, an object of the present invention is to provide a technique capable of efficiently designating an inspection image region for a captured image related to an inspection object.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an example of a schematic configuration of an inspection apparatus;

FIGS. 2A and 2B are diagrams each showing a configuration example of an inspection unit;

FIGS. 3A and 3B are diagrams each showing a configuration example of an inspection unit;

FIG. 4 is a block diagram showing an example of an electrical configuration of the information processing apparatus according to the first preferred embodiment;

FIG. 5 is a diagram for illustrating a position and an attitude of the inspection object and the imaging unit;

FIG. 6 is a block diagram showing an example of a functional configuration achieved by an arithmetic processing unit;

FIG. 7A is a diagram showing a first example of a three-dimensional model of an inspection object;

FIG. 7B is a diagram showing a first example of the surface of the three-dimensional model divided into a plurality of regions by the first region division processing;

FIG. 7C is a diagram showing a first example of the surface of the three-dimensional model divided into a plurality of regions by the second region division processing;

FIG. 8A is a diagram showing a second example of a three-dimensional model of an inspection object;

FIG. 8B is a diagram showing a second example of the surface of the three-dimensional model divided into a plurality of regions by the first region division processing;

FIG. 8C is a diagram showing a third example of the surface of the three-dimensional model divided into a plurality of regions by the first region division processing;

FIG. 9A is a diagram showing an example of a first model image;

FIG. 9B is a diagram showing an example of a reference image;

FIG. 10 is a diagram showing an example of a first superimposition image obtained by superimposing a first model image and a reference image;

FIG. 11A is a diagram showing an example of a second model image;

FIG. 11B is a diagram showing an example of a second superimposition image obtained by superimposing a reference image and a second model image;

FIG. 12 is a diagram showing an example of the region designation image;

FIG. 13 is a diagram showing an example of the inspection condition setting screen;

FIG. 14A is a flowchart showing an example of a flow of image processing according to the first preferred embodiment;

FIG. 14B is a flowchart showing an example of a flow of processing performed in step S1 in FIG. 14A;

FIG. 14C is a flowchart showing an example of a flow of processing performed in step S3 in FIG. 14A;

FIGS. 15A and 15B are diagrams each illustrating a manual matching screen according to the second preferred embodiment;

FIG. 16 is a flowchart showing an example of a flow of a designation step according to the second preferred embodiment;

FIG. 17 is a flowchart showing an example of a flow of a designation step according to the third preferred embodiment;

FIG. 18 is a diagram showing a configuration example of the inspection unit according to the fourth preferred embodiment; and

FIG. 19 is a diagram showing a schematic configuration of an inspection apparatus according to a modification.

### DESCRIPTION OF THE PREFERRED EMBODIMENTS

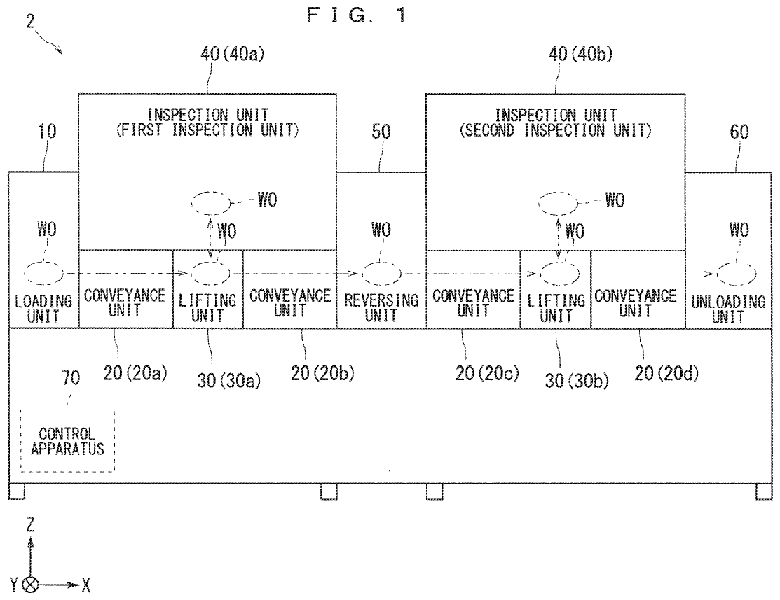

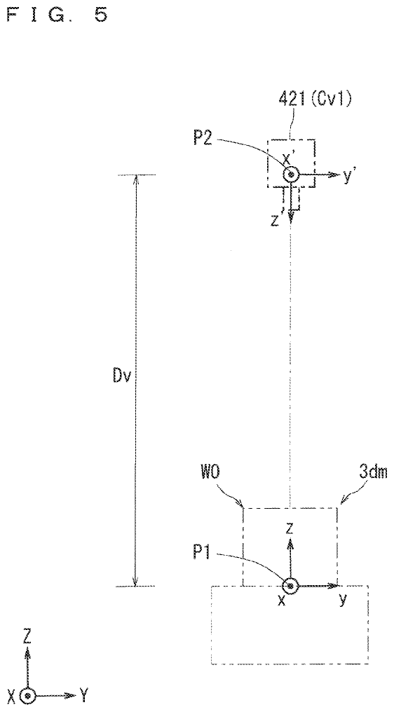

Hereinafter, each of the preferred embodiments of the present invention will be described with reference to the accompanying drawings. The components described in each embodiment are merely examples, and are not intended to limit the scope of the present invention only to them. The drawings are only schematically shown. In the drawings, the dimensions and number of parts may be shown to be exaggerated or simplified as necessary for easy understanding. In addition, in the drawings, parts having similar configurations and functions are denoted by the same reference numerals, and redundant description is omitted as appropriate. In FIGS. 1 to 3B, 5, 18, and 19, a right-handed XYZ coordinate system is assigned. In this XYZ coordinate system, a direction in which an inspection object (also referred to as a workpiece) W0 is conveyed along a horizontal direction in the inspection apparatus 2 in FIG. 1 is a +X direction, a direction orthogonal to the +X direction along a horizontal plane is a +Y direction, and a gravity direction orthogonal to both the +X direction and the +Y direction is a −Z direction. The XYZ coordinate system indicates an azimuth relationship in the real space of the inspection apparatus 2. In FIGS. 5 and 7A to 8C, a right-handed xyz coordinate system (also referred to as a three-dimensional model coordinate system) in the three-dimensional model of the inspection object W0 is assigned. In FIG. 5, a left-handed x′y′z′ coordinate system (also referred to as a camera coordinate system) in the imaging unit 421 is assigned.

### 1. First Preferred Embodiment

### 1-1. Inspection Apparatus

<1-1-1. Schematic Configuration of Inspection Apparatus>

FIG. 1 is a diagram showing an example of a schematic configuration of an inspection apparatus 2. The inspection apparatus 2 is, for example, an apparatus for inspecting an inspection object W0 having a three-dimensional shape. As shown in FIG. 1, the inspection apparatus 2 includes, for example, a loading unit (also referred to as an input unit) 10, four conveyance units 20, two lifting units 30, two inspection units 40, a reversing unit 50, an unloading unit 60, and a control apparatus 70. The four conveyance units 20 include, for example, a first conveyance unit 20a, a second conveyance unit 20b, a third conveyance unit 20c, and a fourth conveyance unit 20d. The two lifting units 30 include, for example, a first lifting unit 30a and a second lifting unit 30b. The two inspection units 40 include, for example, a first inspection unit 40a and a second inspection unit 40b.

In the inspection apparatus 2, for example, under the control of the control apparatus 70, various operations such as conveyance, imaging, and reversal of the inspection object W0 can be performed in the following flow. First, for example, the inspection object W0 is loaded into the loading unit 10 from outside the inspection apparatus 2. Next, for example, the inspection object W0 held in a preset desired attitude (also referred to as a first inspection attitude) is conveyed from the loading unit 10 to the first lifting unit 30a by the first conveyance unit 20a. Next, for example, the inspection object W0 held in the first inspection attitude is raised to the first inspection unit 40a by the first lifting unit 30a. In the first inspection unit 40a, for example, illumination and imaging are performed at a plurality of preset angles on the inspection object W0 held in the first inspection attitude. Next, for example, the inspection object W0 held in the first inspection attitude is lowered below the first inspection unit 40a by the first lifting unit 30a. Next, for example, the inspection object W0 held in the first inspection attitude is conveyed from the first lifting unit 30a to the reversing unit 50 by the second conveyance unit 20b. In the reversing unit 50, for example, the inspection object W0 is vertically reversed and held in a preset desired attitude (also referred to as a second inspection attitude). Next, for example, the inspection object W0 held in the second inspection attitude is conveyed from the reversing unit 50 to the second lifting unit 30b by the third conveyance unit 20c. Next, for example, the inspection object W0 held in the second inspection attitude is raised to the second inspection unit 40b by the second lifting unit 30b. In the second inspection unit 40b, for example, illumination and imaging are performed at a plurality of preset angles on the inspection object W0 held in the second inspection attitude. Next, for example, the inspection object W0 held in the second inspection attitude is lowered below the second inspection unit 40b by the second lifting unit 30b. Next, for example, the inspection object W0 held in the second inspection attitude is conveyed from the second lifting unit 30b to the unloading unit 60 by the fourth conveyance unit 20d. Then, for example, the inspection object W0 is unloaded from the unloading unit 60 to outside the inspection apparatus 2.

Here, for example, the four conveyance units 20 may be integrally configured or may be configured by a plurality of portions. The four conveyance units 20 integrally configured include, for example, a linear motion guide and a drive mechanism. To the linear motion guide, for example, a pair of rails linearly extending from the first conveyance unit 20a to the fourth conveyance unit 20d is applied. To the drive mechanism, for example, a ball screw, a motor, or the like that horizontally moves a holding mechanism, disposed on the linear motion guide, for holding the inspection object W0 is applied. To each of the filling units 30, for example, a configuration or the like in which a holding mechanism for holding the inspection object W0 is raised and lowered by a raising and lowering mechanism such as a cylinder or a motor is applied. To the reversing unit 50, for example, a configuration or the like including a grip unit for gripping the inspection object W0 and an arm unit for moving and rotating the grip unit is applied. The control apparatus 70 includes, for example, an information processing apparatus such as a computer. To the two inspection units 40, for example, a similar configuration is applied.

<1-1-2. Configuration of Inspection Unit>

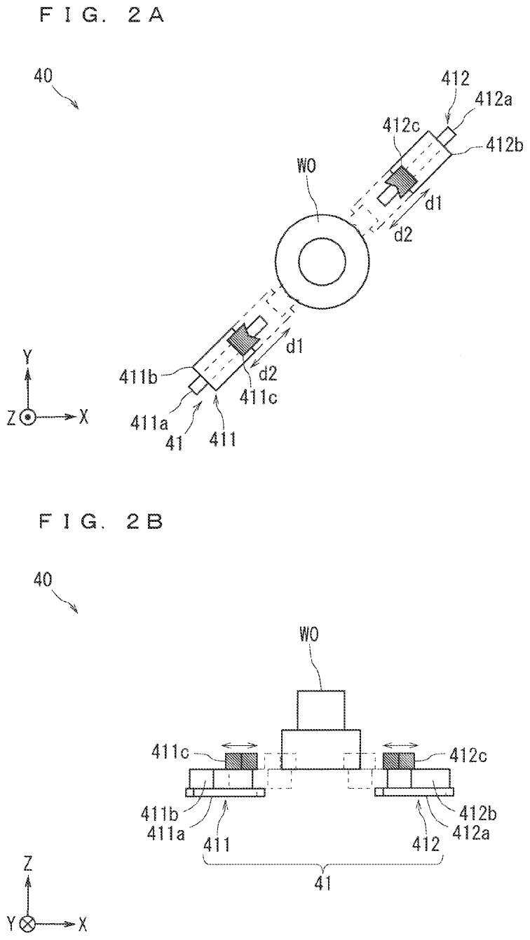

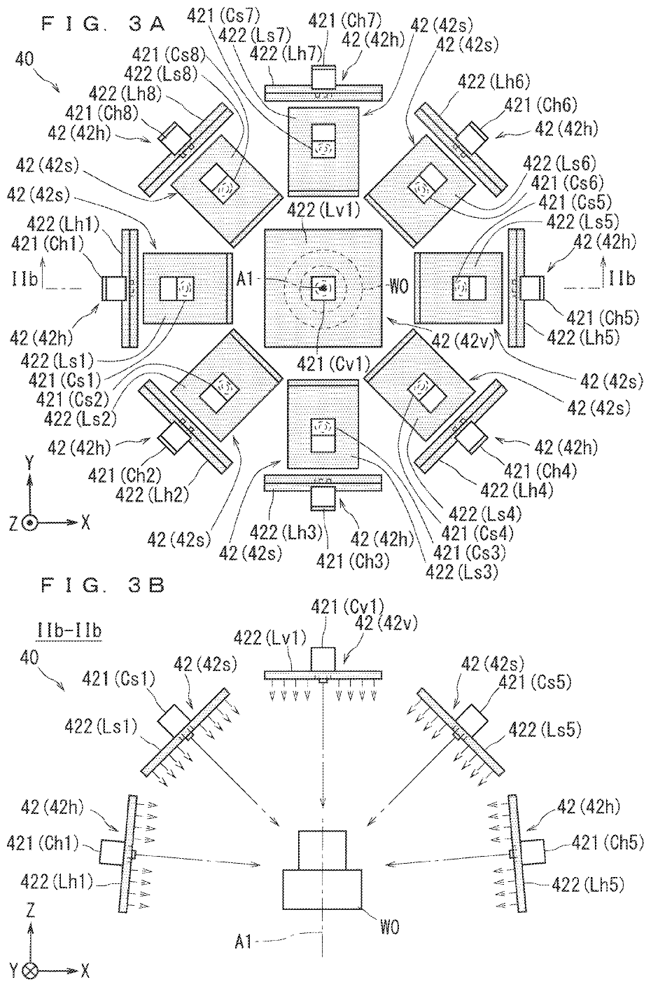

FIGS. 2A to 3B are diagrams showing a configuration example of the inspection unit 40. As shown in FIGS. 2A to 3B, the inspection unit 40 includes, for example, a holding unit 41 and a plurality of imaging modules 42. FIG. 2A shows a plan view schematically drawing a configuration example of the holding unit 41. FIG. 2B shows a front view schematically drawing a configuration example of the holding unit 41. In FIGS. 2A and 2B, illustration of a plurality of imaging modules 42 is omitted for convenience. FIG. 3A shows a plan view drawing an example of arrangement of the plurality of imaging modules 42 in the inspection unit 40. FIG. 3B shows an example of a virtual cutting plane taken along line in FIG. 3A. In FIGS. 3A and 3B, illustration of the holding unit 41 is omitted for convenience.

<1-1-2-1. Holding Unit>

The holding unit 41 is a portion for holding the inspection object W0. For example, the holding unit 41 can hold the inspection object W0 in a desired attitude. For example, the holding unit 41 of the first inspection unit 40a can hold the inspection object W0 in the first inspection attitude. For example, the holding unit 41 of the second inspection unit 40b can hold the inspection object W0 in the second inspection attitude.

As shown in FIGS. 2A and 2B, the holding unit 41 includes, for example, a first portion 411 and a second portion 412. The first portion 411 and the second portion 412 are positioned to face each other in, for example, a first direction d1 along the horizontal direction and a second direction d2 opposite to the first direction d1.

The first portion 411 includes, for example, a first guide portion 411a, a first movable member 411b, and a first sandwiching member 411c. For example, the first guide portion 411a is positioned so as to extend along the first direction d1. For example, a rail member extending linearly along the first direction d1, a pair of guide members extending linearly along the first direction d1, or the like is applied to the first guide portion 411a. The first movable member 411b can move in the first direction d1 and the second direction d2 along the first guide portion 411a by, for example, a driving force applied by a motor or the like. In other words, the first movable member 411b can reciprocate in the first direction d1 and the second direction d2, for example. For example, a rectangular parallelepiped block is applied to the first movable member 411b. The first sandwiching member 411c is fixed on the first movable member 411b, for example, and has an end portion in the first direction d1 having a shape along a part of the outer surface of the inspection object W0.

The second portion 412 includes, for example, a second guide portion 412a, a second movable member 412b, and a second sandwiching member 412c. For example, the second guide portion 412a is positioned so as to extend along the second direction d2. For example, a rail member extending linearly along the second direction d2, a pair of guide members extending linearly along the second direction d2, or the like is applied to the second guide portion 412a. The second movable member 412b can move in the second direction d2 and the first direction d1 along the second guide portion 412a by, for example, a driving force applied by a motor or the like. In other words, the second movable member 412b can reciprocate in the first direction d1 and the second direction d2, for example. For example, a rectangular parallelepiped block is applied to the second movable member 412b. The second sandwiching member 412c is fixed on the second movable member 412b, for example, and has an end portion in the second direction d2 having a shape along a part of the outer surface of the inspection object W0.

Here, for example, when the first movable member 411b is moved in the first direction d1 and the second movable member 412b is moved in the second direction d2 so as to approach the inspection object W0 in a state where the inspection object W0 is disposed between the first portion 411 and the second portion 412, the inspection object W0 is sandwiched between the first sandwiching member 411c and the second sandwiching member 412c. Thus, for example, the inspection object W0 can be held in a desired attitude by the first sandwiching member 411c and the second sandwiching member 412c. In the first inspection unit 40a, for example, the inspection object W0 can be held in the first inspection attitude by the holding unit 41. In the second inspection unit 40b, for example, the inspection object W0 can be held in the second inspection attitude by the holding unit 41.

<1-1-2-2. Plurality of Imaging Modules>

As shown in FIGS. 3A and 3B, each imaging module 42 includes, for example, an imaging unit 421 and an illumination unit 422.

The imaging unit 421 can image the inspection object W0 held by the holding unit 41, for example. In the example in FIGS. 3A and 3B, each imaging unit 421 can image the inspection object W0 held in a desired attitude by the holding unit 41 toward a preset direction (imaging direction). The imaging unit 421 includes, for example, an imaging element and an optical system. For example, a charge coupled device (CCD) or the like is applied to the imaging element. For example, a lens unit or the like for forming an optical image of the inspection object W0 on the imaging element is applied to the optical system.

The illumination unit 422 can illuminate the inspection object W0 held by the holding unit 41, for example. In the example in FIGS. 3A and 3B, each illumination unit 422 can illuminate the inspection object W0 held in a desired attitude by the holding unit 41 toward a preset direction (illumination direction). For example, lighting or the like having a planar light emitting region in which a plurality of light emitting units are two-dimensionally arranged is applied to each illumination unit 422. Thus, for example, the inspection object W0 can be illuminated over a wide range by each illumination unit 422. For example, a light emitting diode (LED) is applied to the light emitting unit.

Here, for example, each imaging module 42 has a similar configuration. Here, for example, in each imaging module 42, the lens unit of the imaging unit 421 is positioned in a state of being inserted into the hole portion of the illumination unit 422. From another point of view, for example, the optical axis in the lens unit of the imaging unit 421 is set to pass through the hole portion of the illumination unit 422. The plurality of imaging modules 42 can image the inspection object W0 at respective different angles. In the example in FIGS. 3A and 3B, the plurality of imaging modules 42 includes 17 imaging modules 42. Therefore, in the example in FIGS. 3A and 3B, the inspection object W0 can be imaged at 17 angles by the 17 imaging modules 42. The 17 imaging modules 42 include one first imaging module 42v, eight second imaging modules 42s, and eight third imaging modules 42h.

<<First Imaging Module>>

The first imaging module 42v includes a first imaging unit Cv1 and a first illumination unit Lv1. The first imaging unit Cv1 is, for example, an imaging unit (also referred to as a ceiling imaging unit or an upper imaging unit) capable of imaging the inspection object W0 toward the gravity direction (−Z direction) as the imaging direction. The first illumination unit Lv1 is, for example, an illumination unit (also referred to as a ceiling illumination unit or an upper illumination unit) capable of illuminating the inspection object W0 toward the gravity direction (−Z direction) as the illumination direction. Therefore, for example, the first imaging unit Cv1 can image, toward the gravity direction (downward direction), at least a part of the inspection object W0 illuminated by the first illumination unit Lv1 as a subject. In other words, for example, the first imaging unit Cv1 can image the inspection object W0 at one angle directed downward direction (also referred to as a downward angle).

<<Second Imaging Module>>

In each of the second imaging modules 42s, the imaging unit 421 can image the inspection object W0 toward the obliquely downward direction as the imaging direction, and the illumination unit 422 can illuminate the inspection object W0 toward the obliquely downward direction as the illumination direction. Therefore, in each second imaging module 42s, for example, the imaging unit 421 can image at least a part of the inspection object W0 illuminated by the illumination unit 422 as a subject toward the obliquely downward direction. In other words, in each second imaging module 42s, for example, the imaging unit 421 can image the inspection object W0 at an angle (also referred to as an obliquely downward angle) directed obliquely downward direction.

The eight second imaging modules 42s include the first to eighth second imaging modules 42s. The first second imaging module 42s includes a second A imaging unit Cs1 and a second A illumination unit Ls1. The second imaging module 42s includes a second B imaging unit Cs2 and a second B illumination unit Ls2. The third second imaging module 42s includes a second C imaging unit Cs3 and a second C illumination unit Ls3. The fourth second imaging module 42s includes a second D imaging unit Cs4 and a second D illumination unit Ls4. The fifth second imaging module 42s includes a second E imaging unit Cs5 and a second E illumination unit Ls5. The sixth second imaging module 42s includes a second F imaging unit Cs6 and a second F illumination unit Ls6. The seventh second imaging module 42s includes a second G imaging unit Cs7 and a second G illumination unit Ls7. The eighth second imaging module 42s includes a second H imaging unit Cs8 and a second H illumination unit Ls8.

In addition, in the first second imaging module 42s, each of the imaging direction and the illumination direction is substantially parallel to the XZ plane and is a direction toward the −Y direction as it advances in the +X direction. Then, the second to eighth second imaging modules 42s are arranged at positions rotated counterclockwise by 45 degrees with reference to the first second imaging module 42s, around a virtual axis (also referred to as a first virtual axis) A1 passing through the region where the inspection object W0 is arranged and which extends along the Z-axis direction. Specifically, the second second imaging module 42s is arranged at a position rotated counterclockwise by 45 degrees from the first second imaging module 42s around the first virtual axis A1. The third second imaging module 42s is arranged at a position rotated counterclockwise by 90 degrees from the first second imaging module 42s around the first virtual axis A1. The fourth second imaging module 42s is arranged at a position rotated counterclockwise by 135 degrees from the first second imaging module 42s around the first virtual axis A1. The fifth second imaging module 42s is arranged at a position rotated counterclockwise by 180 degrees from the first second imaging module 42s around the first virtual axis A1. The sixth second imaging module 42s is arranged at a position rotated counterclockwise by 225 degrees from the first second imaging module 42s around the first virtual axis A1. The seventh second imaging module 42s is arranged at a position rotated counterclockwise by 270 degrees from the first second imaging module 42s around the first virtual axis A1. The eighth second imaging module 42s is arranged at a position rotated counterclockwise by 315 degrees from the first second imaging module 42s around the first virtual axis A1. Therefore, a plurality of imaging units 421 (specifically, the second A imaging unit Cs1, the second B imaging unit Cs2, the second C imaging unit Cs3, the second D imaging unit Cs4, the second E imaging unit Cs5, the second F imaging unit Cs6, the second G imaging unit Cs7, and the second H imaging unit Cs8) in the plurality of second imaging modules 42s can image the inspection object W0 at eight angles (obliquely downward angles) directed obliquely downward different from each other surrounding the inspection object W0.

<<Third Imaging Module>>

In each of the third imaging modules 42h, the imaging unit 421 can image the inspection object W0 toward the substantially horizontal direction as the imaging direction, and the illumination unit 422 can illuminate the inspection object W0 toward the substantially horizontal direction as the illumination direction. Therefore, in each third imaging module 42h, for example, the imaging unit 421 can image at least a part of the inspection object W0 illuminated by the illumination unit 422 as a subject toward the substantially horizontal direction. In other words, in each third imaging module 42h, for example, the imaging unit 421 can image the inspection object W0 at an angle (also referred to as a substantially horizontal angle) directed toward the substantially horizontal direction.

The eight third imaging modules 42h include the first to eighth third imaging modules 42h. The first third imaging module 42h includes a third A imaging unit Ch1 and a third A illumination unit Lh1. The second third imaging module 42h includes a third B imaging unit Ch2 and a third B illumination unit Lh2. The third third imaging module 42h includes a third C imaging unit Ch3 and a third C illumination unit Lh3. The fourth third imaging module 42h includes a third D imaging unit Ch4 and a third D illumination unit Lh4. The fifth third imaging module 42h includes a third E imaging unit Ch5 and a third E illumination unit Lh5. The sixth third imaging module 42h includes a third F imaging unit Ch6 and a third F illumination unit Lh6. The seventh third imaging module 42h includes a third G imaging unit Ch7 and a third G illumination unit Lh7. The eighth third imaging module 42h includes a third H imaging unit Ch8 and a third H illumination unit Lh8. In addition, in the first third imaging module 42h, each of the imaging direction and the illumination direction is substantially parallel to the XZ plane and is a direction inclined by 5 degrees from the +X direction to the gravity direction.

Then, the second to eighth third imaging modules 42h are arranged at positions rotated counterclockwise by 45 degrees with reference to the first third imaging module 42h, around the first virtual axis A1 passing through the region where the inspection object W0 is arranged and extending along the Z-axis direction. Specifically, the second third imaging module 42h is arranged at a position rotated counterclockwise by 45 degrees from the first third imaging module 42h around the first virtual axis A1. The third third imaging module 42h is arranged at a position rotated counterclockwise by 90 degrees from the first third imaging module 42h around the first virtual axis A1. The fourth third imaging module 42h is arranged at a position rotated counterclockwise by 135 degrees from the first third imaging module 42h around the first virtual axis A1. The fifth third imaging module 42h is arranged at a position rotated counterclockwise by 180 degrees from the first third imaging module 42h around the first virtual axis A1. The sixth third imaging module 42h is arranged at a position rotated counterclockwise by 225 degrees from the first third imaging module 42h around the first virtual axis A1. The seventh third imaging module 42h is arranged at a position rotated counterclockwise by 270 degrees from the first third imaging module 42h around the first virtual axis A1. The eighth third imaging module 42h is arranged at a position rotated counterclockwise by 315 degrees from the first third imaging module 42h around the first virtual axis A1. Therefore, a plurality of imaging units 421 (specifically, the third A imaging unit Ch1, the third B imaging unit Ch2, the third C imaging unit Ch3, the third D imaging unit Ch4, the third E imaging unit Ch5, the third F imaging unit Ch6, the third G imaging unit Ch7, and the third H imaging unit Ch8) in the plurality of third imaging modules 42h can image the inspection object W0 at eight angles (substantially horizontal angles) directed toward substantially horizontal directions different from each other surrounding the inspection object W0.

Here, image data obtained by imaging in each imaging unit 421 may be stored in, for example, a storage unit of the control apparatus 70, or may be transmitted to an apparatus (also referred to as an external apparatus) outside the inspection apparatus 2 via a communication line or the like. Then, for example, in the control apparatus 70 or the external apparatus, inspection for detecting the presence or absence of the defect of the inspection object W0 can be performed by various types of image processing using the image data. Here, the external apparatus may include, for example, the information processing apparatus 1 and the like.

### 1-2. Information Processing Apparatus

<1-2-1. Schematic Configuration of Information Processing Apparatus>

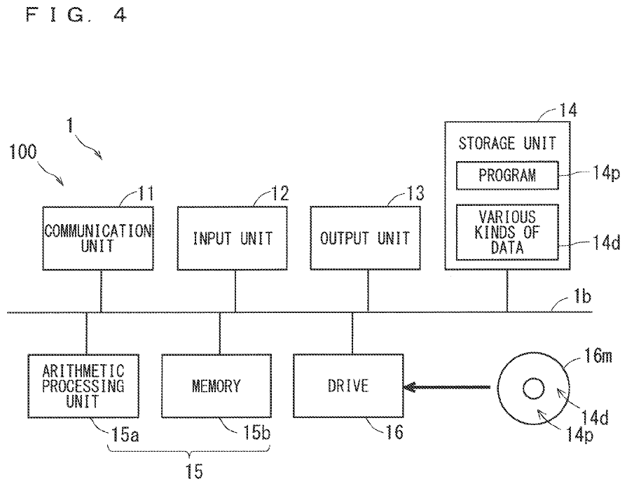

FIG. 4 is a block diagram showing an example of an electrical configuration of the information processing apparatus 1 according to the first preferred embodiment. As shown in FIG. 4, the information processing apparatus 1 is implemented by, for example, a computer or the like. The information processing apparatus 1 includes, for example, a communication unit 11, an input unit 12, an output unit 13, a storage unit 14, a control unit 15, and a drive 16 connected via a bus line 1b.

The communication unit 11 has, for example, a function capable of performing data communication with an external apparatus via a communication line or the like. The communication unit 11 can receive, for example, a computer program (hereinafter, abbreviated as a program) 14p, various kinds of data 14d, and the like.

The input unit 12 has a function of accepting an input of information in response to, for example, a motion of a user who uses the information processing apparatus 1. The input unit 12 may include, for example, an operation unit, a microphone, various sensors, and the like. The operation unit may include, for example, a mouse and a keyboard capable of inputting a signal corresponding to a user's operation. The microphone can input a signal corresponding to the user's voice, for example. The various sensors can input signals corresponding to the movement of the user, for example.

The output unit 13 has, for example, a function capable of outputting various types of information in a mode that can be recognized by the user. The output unit 13 may include, for example, a display unit, a projector, a speaker, and the like. The display unit can, for example, visibly output various types of information in a mode that can be recognized by the user. To the display unit, for example, a liquid crystal display, an organic EL display, or the like can be applied. The display unit may have a form of a touch panel integrated with the input unit 12. The projector can, for example, visibly output various types of information onto an object onto which projection is to be made such as a screen, in a mode that can be recognized by the user. The projector and the object onto which projection is to be made can cooperate with each other to function as a display unit that visibly outputs various types of information in a mode that can be recognized by the user. The speaker can, for example, audibly output various types of information in a mode that can be recognized by the user.

The storage unit 14 has, for example, a function capable of storing various types of information. The storage unit 14 can include, for example, a non-volatile storage medium such as a hard disk or a flash memory. In the storage unit 14, for example, any of a configuration including one storage medium, a configuration including two or more storage media integrally, and a configuration including two or more storage media divided into two or more portions may be adopted. The storage unit 14 can store, for example, a program 14p and various kinds of data 14d. The various kinds of data 14d may include three-dimensional model information and position attitude information. The three-dimensional model information is, for example, information related to a three-dimensional shaped model (also referred to as a three-dimensional model) 3dm of the inspection object W0. The position attitude information is, for example, information related to the position and attitude concerning the imaging unit 421 and the inspection object W0 in the inspection apparatus 2. The various kinds of data 14d may include, for example, information related to a reference image for each imaging unit 421. The reference image is, for example, information related to an image obtained by imaging the inspection object W0 by the imaging unit 421. Regarding each imaging unit 421, for example, the reference image can be acquired by imaging the inspection object W0 held in a desired attitude by the holding unit 41 of the inspection unit 40 using the imaging unit 421 in advance. The various kinds of data 14d may include, for example, information (also referred to as imaging parameter information) related to parameters such as an angle of view and a focal length that define a region that can be imaged by each imaging unit 421.

For example, design data (also referred to as object design data) or the like about the three-dimensional shape of the inspection object W0 is applied to the three-dimensional model information. For example, data in which the three-dimensional shape of the inspection object W0 is expressed by a plurality of planes such as a plurality of polygons is applied to the object design data. This data includes, for example, data defining the position and orientation of each plane. For example, a triangular plane or the like is applied to the plurality of planes. For example, data or the like of coordinates of three or more vertices that define the outer shape of the plane is applied to the data that defines the position of each plane. For example, data or the like of a vector (also referred to as a normal vector) indicating a direction (also referred to as a normal direction) in which the normal of the plane extends is applied to the data defining the orientation of each plane. In the three-dimensional model information, as shown in FIG. 5, the position and attitude of the three-dimensional model 3dm of the inspection object W0 can be indicated using an xyz coordinate system (three-dimensional model coordinate system), with a position, as an origin, corresponding to a reference position (also referred to as a first reference position) P1 of a region where the inspection object W0 is disposed in the inspection unit 40, for example. Specifically, for example, the position of the three-dimensional model 3dm of the inspection object W0 can be indicated by an x coordinate, a y coordinate, and a z coordinate, and the attitude of the three-dimensional model 3dm of the inspection object W0 can be indicated by a rotation angle Rx around the x axis, a rotation angle Ry around the y axis, and a rotation angle Rz around the z axis.

To the position attitude information, for example, design information or the like can be applied that makes clear a relative positional relationship, a relative angular relationship, a relative attitudinal relationship, and the like between the inspection object W0 held in a desired attitude by the holding unit 41 of the inspection unit 40, and each imaging unit 421 of the inspection unit 40. For example, as shown in FIG. 5, the position attitude information may include information on coordinates of a reference position (first reference position) P1 of a region where the inspection object W0 is disposed in the inspection unit 40, information on coordinates of a reference position (also referred to as a second reference position) P2 for each imaging unit 421, information on an xyz coordinate system (three-dimensional model coordinate system) having a reference point corresponding to the first reference position P1 as an origin, information on an x′y′z′ coordinate system (camera coordinate system) having a reference point corresponding to the second reference position P2 for each imaging unit 421 as an origin, and the like. Here, for example, the z′ axis of the x′y′z′ coordinate system according to each imaging unit 421 is an axis along the optical axis of the optical system of the imaging unit 421, and is set to pass through the first reference position P1. Here, for example, the first imaging unit Cv1 is set such that the z axis of the xyz coordinate system and the z′ axis of the x′y′z′ coordinate system have a relationship of being positioned on the same straight line and having opposite orientations, the x axis and the x′ axis have a relationship of being parallel to each other and having the same orientation, and the y axis and the y′ axis have a relationship of being parallel to each other and having the same orientation.

The control unit 15 includes, for example, an arithmetic processing unit 15a that acts as a processor, a memory 15b that can temporarily store information, and the like. For example, an electric circuit such as a central processing unit (CPU) is applied to the arithmetic processing unit 15a. In this case, the arithmetic processing unit 15a includes, for example, one or more processors. For example, a random access memory (RAM) or the like is applied to the memory 15b. In the arithmetic processing unit 15a, for example, the program 14p stored in the storage unit 14 is read and executed. Thus, the information processing apparatus 1 can function as, for example, an apparatus (also referred to as an image processing apparatus) 100 that performs various types of image processing. In other words, for example, the program 14p is executed by the arithmetic processing unit 15a included in the information processing apparatus 1, whereby the information processing apparatus 1 can be caused to function as the image processing apparatus 100. Here, the storage unit 15 stores the program 14p and has a role as a non-transitory computer readable recording medium, for example. For example, with respect to an image (also referred to as a captured image) that can be acquired by imaging the inspection object W0 at a predetermined angle in the inspection unit 40 of the inspection apparatus 2 shown in FIGS. 1 to 3B, the image processing apparatus 100 can create information (also referred to as region designation information) that designates a region (also referred to as an inspection image region) in which a portion to be inspected of the inspection object W0 is expected to be captured. For example, in the image processing apparatus 100, before the continuous inspection is performed on a plurality of inspection objects W0 based on the same design, or in the initial stage of the continuous inspection, the region designations information designating the region (inspection image region) in which the portion to be inspected is expected to be captured in the captured image that can be acquired by the imaging of the inspection object W0 by the imaging unit 421 may be created, or before the inspection is performed on one or more inspection objects W0 or at the time of the inspection, the region designation information designating the region (inspection image region) in which the portion to be inspected is expected to be captured in the captured image that can be acquired by the imaging of the inspection object W0 by the imaging unit 421 may be created. Various types of information temporarily obtained by various types of information processing in the control unit 15 can be appropriately stored in the memory 15b or the like.

The drive 16 is, for example, a portion to and from which the portable storage medium 16m can be attached and detached. In the drive 16, for example, data can be exchanged between the storage medium 16m and the control unit 15 in a state where the storage medium 16m is mounted. Here, for example, mounting the storage medium 16m storing the program 14p on the drive 16 may read and store the program 14p from the storage medium 16m into the storage unit 14. Here, the storage medium 16m stores the program 14p and has a role as a non-transitory computer readable recording medium, for example. In addition, for example, mounting the storage medium 16m storing the various kinds of data 14d or part of data of the various kinds of data 14d on the drive 16 may read and store the various kinds of data 14d or part of data of the various kinds of data 14d from the storage medium 16m into the storage unit 14. Part of data of the various kinds of data 14d may include, for example, three-dimensional model information or position attitude information.

<1-2-2. Functional Configuration of Image Processing Apparatus>

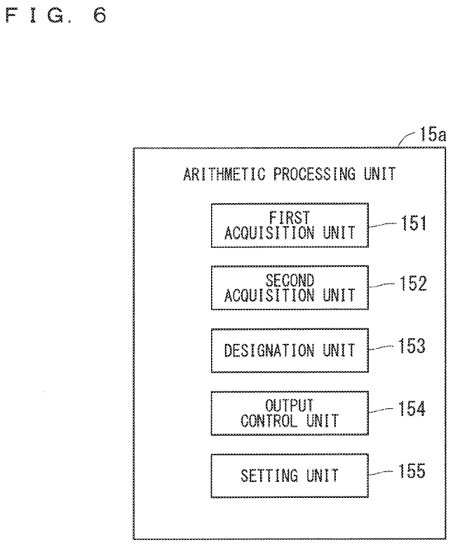

FIG. 6 is a block diagram illustrating a functional configuration implemented by the arithmetic processing unit 15a. FIG. 6 illustrates various functions related to data processing achieved by executing the program 14p in the arithmetic processing unit 15a.

As shown in FIG. 6, the arithmetic processing unit 15a includes, for example, a first acquisition unit 151, a second acquisition unit 152, a designation unit 153, an output control unit 154, and a setting unit 155 as a functional configuration to be achieved. As a work space in the processing of each of these units, for example, the memory 15b is used. At least some of the functions of the functional configuration implemented by the arithmetic processing unit 15a may be configured by hardware such as a dedicated electronic circuit, for example.

<1-2-2-1. First Acquisition Unit>

For example, the first acquisition unit 151 has a function of acquiring information (three-dimensional model information) related to the three-dimensional model 3dm of the inspection object W0 and information (also referred to as inspection region information) related to a region (also referred to as an inspection region) of a portion to be inspected in the three-dimensional model 3dm of the inspection object W0. Here, the first acquisition unit 151 can acquire, for example, three-dimensional model information stored in the storage unit 14.

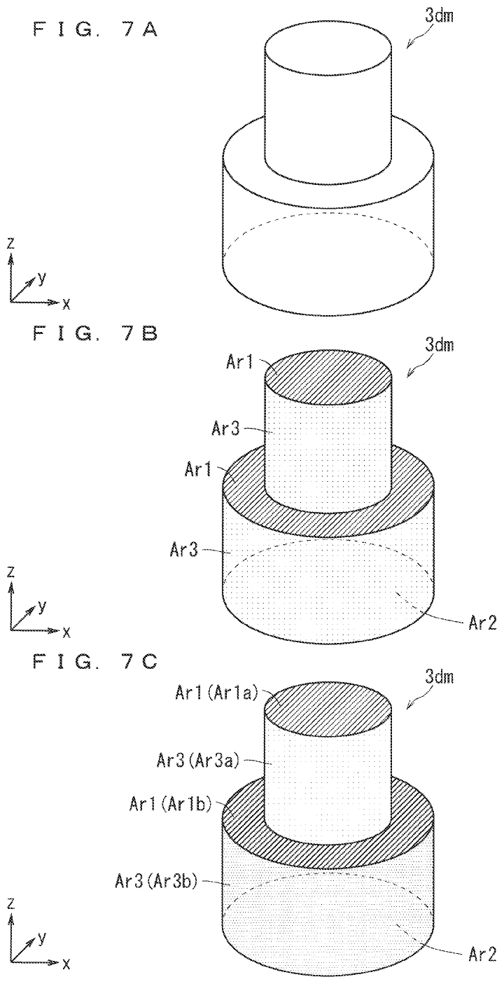

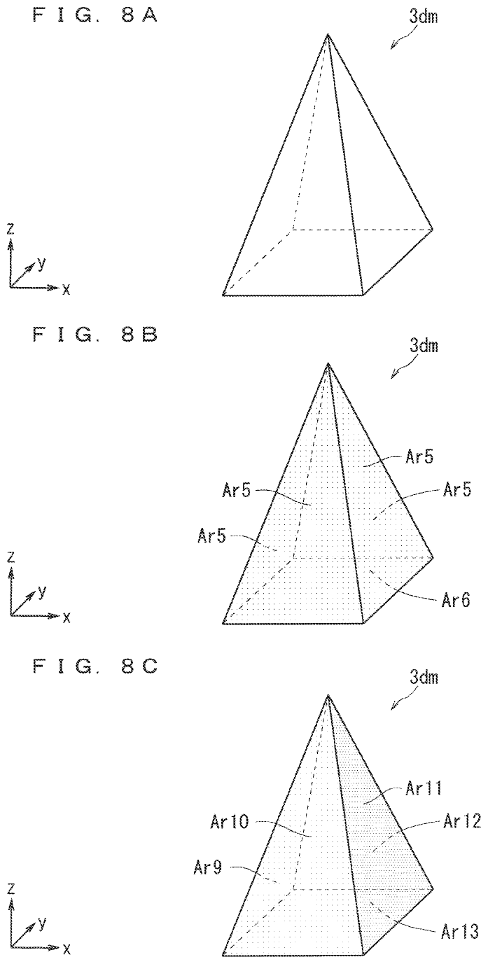

FIG. 7A is a diagram showing a first example of the three-dimensional model 3dm of the inspection object W0. In the example in FIG. 7A, the three-dimensional model 3dm has a shape in which two cylinders are stacked. FIG. 8A is a diagram showing a second example of the three-dimensional model 3dm of the inspection object W0. In the example in FIG. 8A, the three-dimensional model 3dm has a quadrangular pyramidal shape.

In the first preferred embodiment, for example, the first acquisition unit 151 can acquire the inspection region information by dividing the surface of the three-dimensional model 3dm into a plurality of regions (also referred to as unit inspection regions) based on the information related to the orientations of a plurality of planes constituting the three-dimensional model 3dm and the connection state of the planes in the plurality of planes. Thus, for example, the inspection region information in the three-dimensional model 3dm can be easily acquired. For example, information for specifying a plurality of unit inspection regions obtained by dividing the surface of the three-dimensional model 3dm of the inspection object W0 is applied to the inspection region information. Here, for example, a set of the three-dimensional model information and the inspection region information serves as information concerning the three-dimensional model 3dm in which the surface is divided into a plurality of unit inspection regions.

In the first preferred embodiment, for example, the first acquisition unit 151 can perform the first region division processing and the second region division processing in this order. The first region division processing is, for example, processing of dividing the surface of the three-dimensional model 3dm into a plurality of regions based on the information related to the orientations of a plurality of planes constituting the three-dimensional model 3dm. As the information regarding the orientation of each plane, for example, a normal vector of the plane is used. The second region division processing is, for example, processing of further dividing the surface of the three-dimensional model 3dm having been divided into a plurality of regions by the first region division processing into a plurality of regions based on a connection state of planes in a plurality of planes constituting the three-dimensional model 3dm.

<<First Region Division Processing>>

In the first region division processing, for example, the surface of the three-dimensional model 3dm is divided into a plurality of regions according to a predetermined rule (also referred to as a division rule). As the division rule, for example, a rule can be considered in which a plane in which the direction of the normal vector is within a predetermined range belongs to a predetermined region. For example, a rule can be considered in which the surface of the three-dimensional model 3dm is divided into a surface region (also referred to as an upper surface region) facing a direction opposite to the gravity direction (also referred to as an upward direction), a surface region (also referred to as a side surface region) facing a direction along the horizontal direction, and a surface region (also referred to as a lower surface region) facing the gravity direction (also referred to as a downward direction). In other words, for example, a division rule can be considered in which the surface of the three-dimensional model 3dm is divided into the upper surface region, the side surface region, and the lower surface region as three regions. Here, for example, a division rule can be considered in which a plane in which the direction of the normal vector is within a range of inclination (also referred to as a first predetermined range) within a first angle (for example, 45 degrees) with reference to the upward direction (+z direction) belongs to the upper surface region as the first predetermined region, a plane in which the direction of the normal vector is within a range of inclination (also referred to as a second predetermined range) within a second angle (for example, 45 degrees) with reference to the downward direction (−z direction) belongs to the lower surface region as the second predetermined region, and a plane in which the direction of the normal vector is within a remaining range (also referred to as a third predetermined range) not overlapping any of the first predetermined range and the second predetermined range belongs to the side surface region as the third predetermined region.

FIG. 7B is a diagram showing a first example of the surface of the three-dimensional model 3dm divided into a plurality of regions by the first region division processing. FIG. 7B illustrates a state in which a plurality of planes constituting the surface of the three-dimensional model 3dm shown in FIG. 7A is divided into an upper surface region Ar1, a lower surface region Ar2, and a side surface region Ar3.

For example, another rule may be applied to the division rule in the first region division processing. For example, a division rule can be considered in which the surface of the three-dimensional model 3dm is divided into a region (upper surface region) of a surface facing upward direction, a region (also referred to as an oblique upper surface region) of a surface facing obliquely upward direction, a region (side surface region) of a surface facing a direction along the horizontal direction, a region (also referred to as an oblique lower surface region) of a surface facing obliquely downward direction, and a region (lower surface region) of a surface facing downward direction. In other words, for example, a division rule can be considered in which the surface of the three-dimensional model 3dm is divided into an upper surface region, an oblique upper surface region, a side surface region, an oblique lower surface region, and a lower surface region as five regions. Here, for example, a division rule can be considered in which a plane in which the direction of the normal vector is within a range of inclination (also referred to as a fourth predetermined range) less than a third angle (for example, 30 degrees) with reference to upward direction (+z direction) belongs to an upper surface region as a fourth predetermined region, a plane in which the direction of the normal vector is within a range of inclination (also referred to as a fifth predetermined range) from the third angle (for example, 30 degrees) to the fourth angle (for example, 60 degrees) with reference to an upward direction (+z direction) belongs to an oblique upper surface region as a fifth predetermined region, a plane in which the direction of the normal vector is within a range of inclination (also referred to as a sixth predetermined range) less than a fifth angle (for example, 30 degrees) with reference to downward direction (−z direction) belongs to a lower surface region as a sixth predetermined region, a plane in which the direction of the normal vector is within an inclination range (also referred to as a seventh predetermined range) from a fifth angle (for example, 30 degrees) to a sixth angle (for example, 60 degrees) with reference to downward direction (−z direction) belongs to an oblique lower surface region as a seventh predetermined region, and a plane in which the direction of the normal vector is within a remaining range (also referred to as an eighth predetermined range) not overlapping any of the fourth predetermined range to the seventh predetermined range belongs to the side surface region as the eighth predetermined region.

FIG. 8B is a diagram showing a second example of the surface of the three-dimensional model 3dm divided into a plurality of regions by the first region division processing. FIG. 8B illustrates a state in which a plurality of planes constituting the surface of the three-dimensional model 3dm shown in FIG. 8A is divided into an upper surface region, an oblique upper surface region, a lower surface region, an oblique lower surface region, and a side surface region. Specifically, FIG. 8B shows a state in which a plurality of planes constituting the surface of the three-dimensional model 3dm shown in FIG. 8A is divided into an oblique upper surface region Ar5 and a lower surface region Ar6.

<<Second Region Division Processing>>

In the second region division processing, for example, for each region obtained by the first region division processing, a region connected in the three-dimensional model 3dm can be divided as a region of one lump. In other words, for each region obtained by the first region division processing, a region not connected in the three-dimensional model 3dm is divided into another unit inspection region. Thus, for example, finer inspection region information in the three-dimensional model 3dm can be easily acquired. FIG. 7C is a diagram showing a first example of the surface of the three-dimensional model 3dm divided into a plurality of regions by the second region division processing. FIG. 7C illustrates a state in which the upper surface region Ar1 shown in FIG. 7B is divided into a first upper surface region Ar1a and a second upper surface region Ar1b that are not connected to each other, and the side surface region Ar3 shown in FIG. 7B is divided into a first side surface region Ar3a and a second side surface region Ar3b that are not connected to each other. In other words, FIG. 7C illustrates an example of a state in which the surface of the three-dimensional model 3dm shown in FIG. 7A is divided into the first upper surface region Aria, the second upper surface region Ar1b, the lower surface region Ar2, the first side surface region Ar3a, and the second side surface region Ar3b as five unit inspection regions.

<1-2-2-2. Second Acquisition Unit>

The second acquisition unit 152 has, for example, a function of acquiring information (position attitude information) regarding the position and attitude concerning the imaging unit 421 and the inspection object W0 in the inspection apparatus 2. Here, the second acquisition unit 152 can acquire, for example the position attitude information stored in the storage unit 14.

<1-2-2-3. Designation Unit>

For example, based on the three-dimensional model information and the inspection region information acquired by the first acquisition unit 151 and the position attitude information acquired by the second acquisition unit 152, the designation unit 153 can create region designation information for designating the inspection image region corresponding to the inspection region for the captured image that can be acquired by the imaging of the inspection object W0 by each imaging unit 421. In the first preferred embodiment, the designation unit 153 performs processing of, for example, [A] generation of a first model image Im1, [B] generation of a plurality of second model images Im2, [C] detection of one model image, and [D] creation of region designation information about the captured image.

<<[A] Generation of First Model Image Im1>>

For example, the designation unit 153 can generate an image (also referred to as a first model image) Im1 in which the inspection object W0 is virtually captured by each imaging unit 421 based on the three-dimensional model information and the position attitude information. Here, for example, the imaging parameter information regarding each imaging unit 421 stored in the storage unit 14 or the like can be appropriately used.

Here, for example, a case of generating the first model image Im1 virtually capturing the three-dimensional model 3dm by each imaging unit 421 in the examples in FIGS. 3A and 3B using the relationship between the xyz coordinate system (three-dimensional model coordinate system) and the x′y′z′ coordinate system (camera coordinate system) shown in FIG. 5 will be described. Here, for example, the position and attitude of the three-dimensional model 3dm in the xyz coordinate system (three-dimensional model coordinate system) are set as (x, y, z, Rx, Ry, Rz)=(0, 0, 0, 0, 0, 0), and regarding the x′y′z′ coordinate system (camera coordinate system), a rotation angle around the x′ axis is set as Rx′, a rotation angle around the y′ axis is set as Ry′, and a rotation angle around the z′ axis is set as Rz′.

Regarding the first imaging unit Cv1 in the example in FIGS. 3A and 3B, as shown in FIG. 5, a case is assumed where a design distance (also referred to as a distance between origins) between the origin of the xyz coordinate system (three-dimensional model coordinate system) and the origin of the x′y′z′ coordinate system (camera coordinate system) is Dv. In this case, for example, there are relationships of x′=x, y′=y, z′=(Dv-z), Rx′=Rx, Ry′=Ry, and Rz′=Rz between the xyz coordinate system (three-dimensional model coordinate system) and the x′y′z′ coordinate system (camera coordinate system). Therefore, the parameters indicating the position and attitude of the three-dimensional model 3dm in the x′y′z′ coordinate system (camera coordinate system) is (x′, y′, z′, Rx′, Ry′, Rz′)=(0, 0, Dv, 0, 0, 0). These parameters can serve as, for example, parameters (also referred to as position attitude parameters) indicating a design relationship between the position and attitude of the first imaging unit Cv1 and the position and attitude of the three-dimensional model 3dm. This position attitude parameter indicates that, for example, rotations of the rotation angle Rz′, the rotation angle Ry′, and the rotation angle Rx′ are performed in this order allows the attitude of the three-dimensional model 3dm in the xyz coordinate system (three-dimensional model coordinate system) to be transformed into the attitude of the three-dimensional model 3dm in the x′y′z′ coordinate system (camera coordinate system). In addition, this position attitude parameter indicates that the position of the three-dimensional model 3dm in the xyz coordinate system (three-dimensional model coordinate system) can be transformed into the position of the three-dimensional model 3dm in the x′y′z′ coordinate system (camera coordinate system), for example, based on the numerical values of the x′ coordinate, the y′ coordinate, and the z′ coordinate.

Regarding the second A imaging unit Cs1 in the example in FIGS. 3A and 3B, if the design distance between origins is Ds1, the parameters indicating the position and attitude of the three-dimensional model 3dm in the x′y′z′ coordinate system is (x′, y′, z′, Rx′, Ry′, Rz′)=(0, 0, Ds1, −45, 0, 90). These parameters can serve as, for example, parameters (position attitude parameters) indicating a design relationship between the position and attitude of the second A imaging unit Cs1 and the position and attitude of the three-dimensional model 3dm. This position attitude parameter indicates that, for example, rotations of the rotation angle Rz′, the rotation angle Ry′, and the rotation angle Rx′ are performed in this order allows the attitude of the three-dimensional model 3dm in the xyz coordinate system (three-dimensional model coordinate system) to be transformed into the attitude of the three-dimensional model 3dm in the x′y′z′ coordinate system (camera coordinate system). In addition, this position attitude parameter indicates that the position of the three-dimensional model 3dm in the xyz coordinate system (three-dimensional model coordinate system) can be transformed into the position of the three-dimensional model 3dm in the x′y′z′ coordinate system (camera coordinate system), for example, based on the numerical values of the x′ coordinate, the y′ coordinate, and the z′ coordinate.

Regarding the second B imaging unit Cs2 in the example in FIGS. 3A and 3B, if the design distance between origins is Ds2, the parameters (position attitude parameters) indicating the position and attitude of the three-dimensional model 3dm in the x′y′z′ coordinate system (camera coordinate system) is (x′, y′, z′, Rx′, Ry′, Rz′)=(0, 0, Ds2, −45, 0, 45). Regarding the second C imaging unit Cs3 in the example in FIGS. 3A and 3B, if the design distance between origins is Ds3, the parameters (position attitude parameters)) indicating the position and attitude of the three-dimensional model 3dm in the x′y′z′ coordinate system (camera coordinate system) (x′, y′, z′, Rx′, Ry′, Rz′)=(0, 0, Ds3, −45, 0, 0). Regarding the second D imaging unit Cs4 in the example in FIGS. 3A and 3B, if the design distance between origins is Ds4, the parameters (position attitude parameters) indicating the position and attitude of the three-dimensional model 3dm in the x′y′z′ coordinate system (camera coordinate system) is (x′, y′, z′, Rx′, Ry′, Rz′)=(0, 0, Ds4, −45, 0, −45). Regarding the second E imaging unit Cs5 in the example in FIGS. 3A and 3B, if the design distance between origins is Ds5, the parameters (position attitude parameters) indicating the position and attitude of the three-dimensional model 3dm in the x′y′z′ coordinate system (camera coordinate system) (x′, y′, z′, Rx′, Ry′, Rz′)=(0, 0, Ds5, −45, 0, −90). Regarding the second F imaging unit Cs6 in the example in FIGS. 3A and 3B, if the design distance between origins is Ds6, the parameters (position attitude parameters) indicating the position and attitude of the three-dimensional model 3dm in the x′y′z′ coordinate system (camera coordinate system) is (x′, y′, Rx′, Ry′, Rz′)=(0, 0, Ds6, −45, 0, −135). Regarding the second C imaging unit Cs7 in the example in FIGS. 3A and 3B, if the design distance between origins is Ds7, the parameters (position attitude parameters)indicating the position and attitude of the three-dimensional model 3dm in the x′y′z′ coordinate system (camera coordinate system) is (x′, y′, z′, Rx′, Ry′, Rz′)=(0, 0, Ds7, −45, 0, 180). Regarding the second H imaging unit Cs8 in the example in FIGS. 3A and 3B, if the design distance between origins is Ds8, the parameters (position attitude parameters) indicating the position and attitude of the three-dimensional model 3dm in the x′y′z′ coordinate system (camera coordinate system) is (x′, y′, z′, Rx′, Ry′, Rz′)=(0, 0, Ds8, −45, 0, 135).

Regarding the third A imaging unit Ch1 in the example in FIGS. 3A and 3B, if the design distance between origins is Dh1, the parameters (position attitude parameters) indicating the position and attitude of the three-dimensional model 3dm in the x′y′z′ coordinate system is (x′, y′, z′, Rx′, Ry′, Rz′)=(0, 0, Dh1, −85, 0, 90). These parameters can serve as, for example, parameters (position attitude parameters^{.}) indicating a design relationship between the position and attitude of the third A imaging unit Ch1 and the position and attitude of the three-dimensional model 3dm. This position attitude parameter also indicates that, for example, rotations of the rotation angle Rz′, the rotation angle Ry′, and the rotation angle Rx′ are performed in this order allows the attitude of the three-dimensional model 3dm in the xyz coordinate system (three-dimensional model coordinate system) to be transformed into the attitude of the three-dimensional model 3dm in the x′y′z′ coordinate system cat era coordinate system). In addition, this position attitude parameter indicates that the position of the three-dimensional model 3dm in the xyz coordinate system (three-dimensional model coordinate system) can be transformed into the position of the three-dimensional model 3dm in the x′y′z′ coordinate system (camera coordinate system), for example, based on the numerical values of the x′ coordinate, the y′ coordinate, and the z′ coordinate.

Regarding the third B imaging unit Ch2 in the example in FIGS. 3A and 3B, if the design distance between origins is Dh2, the parameters (position attitude parameters) indicating the position and attitude of the three-dimensional model 3dm in the x′y′z′ coordinate system (camera coordinate system) is (x′, y′, z′, Rx′, Ry′, Rz′)=(0, 0, Dh2, 85, 0, 45). Regarding the third C imaging unit Ch3 in the example in FIGS. 3A and 3B, if the design distance between origins is Dh3, the parameters (position attitude parameters) indicating the position and attitude of the three-dimensional model 3dm in the x′y′z′ coordinate system (camera coordinate system) is (x′, y′, z′, Rx′, Ry′, Rz′)=(0, 0, Dh3, −85, 0, 0). Regarding the third D imaging unit Ch4 in the example in FIGS. 3A and 3B, if the design distance between origins is Dh4, the parameters (position attitude parameters) indicating the position and attitude of the three-dimensional model 3dm in the x′y′z′ coordinate system (camera coordinate system (x′, y′, z′, Rx′, Ry′, Rz′)=(0, 0, Dh4, −85, 0, −45). Regarding the third E imaging unit Ch5 in the example in FIGS. 3A and 3B, if the design distance between origins is Dh5, the parameters (position attitude parameters) indicating the position and attitude of the three-dimensional model 3dm in the x′y′z′ coordinate system (camera coordinate system) is (x′, y′, z′, Rx′, Ry′, Rz′)=(0, 0, Dh5, −85, 0, −90). Regarding the third F imaging unit Ch6 in the example in FIGS. 3A and 3B, if the design distance between origins is Dh6, the parameters (position attitude parameters) indicating the position and attitude of the three-dimensional model 3dm in the x′y′z′ coordinate system (camera coordinate system) is (x′, y′, z′, Rx′, Ry′, Rz′)=(0, 0, Dh6, −85, 0, −135). Regarding the third G imaging unit Ch7 in the example in FIGS. 3A and 3B, if the design distance between origins is Dh7, the parameters (position attitude parameters) indicating the position and attitude of the three-dimensional model 3dm in the x′y′z′ coordinate system (camera coordinate system) is (x′, y′, z′, Rx′, Ry′, Rz′)=(0, 0, Dh7, −85, 0, 180). Regarding the third H imaging unit Ch8 in the example in FIGS. 3A and 3B, if the design distance between origins is Dh8, the parameters (position attitude parameters) indicating the position and attitude of the three-dimensional model 3dm in the x′y′z′ coordinate system (camera coordinate system) is (x′, y′, z′, Rx′, Ry′, Rz′)=(0, 0, Dh8, −85, 0, 135).

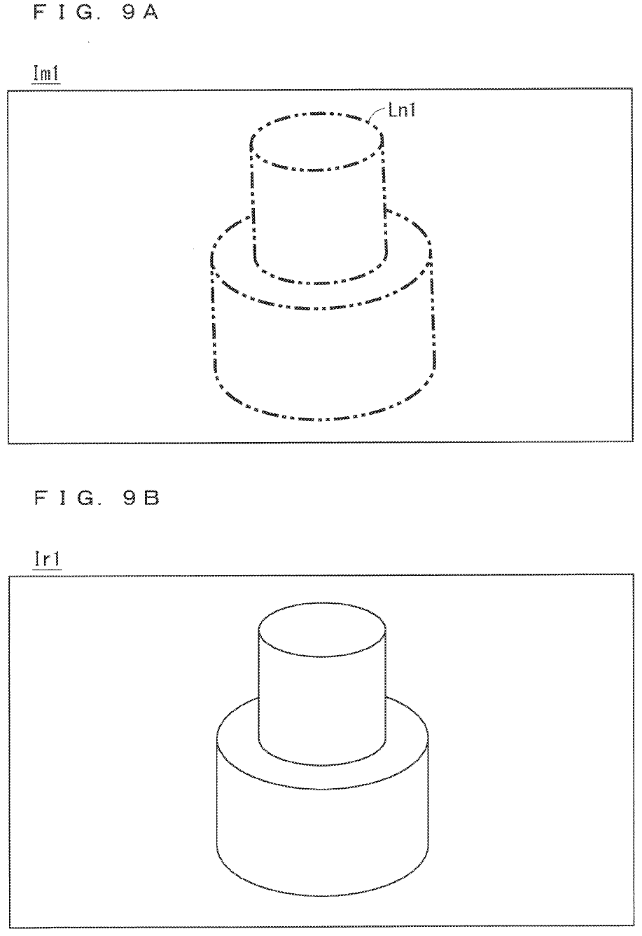

Here, for example, regarding each imaging unit 421, the first model image Im1 in which the three-dimensional model 3dm is virtually captured by the imaging unit 421 can be generated based on the parameters (position attitude parameters) related to the position and attitude of the three-dimensional model 3dm in the x′y′z′ coordinate system (camera coordinate system) and the three-dimensional model information. At this time, for example, the position and attitude of the three-dimensional model 3dm in the xyz coordinate system (three-dimensional model coordinate system) are transformed into the position and attitude in the x′y′z′ coordinate system (camera coordinate system) according to the position attitude parameters, and then the three-dimensional model 3dm is projected on the two-dimensional plane, whereby the first model image Im1 can be generated, Here, for example, by a method such as rendering, the three-dimensional model 3dm is projected on a two-dimensional plane with the origin of the camera coordinate system as a reference point and the z′ axis direction of the camera coordinate system as an imaging direction. At this time, for example, the imaging parameter information regarding each imaging unit 421 stored in the storage unit 14 or the like can be appropriately used. For example, a line drawing in which a portion corresponding to the contour of the three-dimensional model 3dm is drawn with a predetermined type of line (also referred to as a first contour line) Ln1 can be applied to the first model image Im1. In the first model image Im1, for example, a portion corresponding to the outer edge and the corner portion of the three-dimensional model 3dm is the first contour line Ln1. The first contour line Ln1 may be, for example, any line such as a two-dot chain line, a dash-dot line, a broken line, a thick line, or a thin line. FIG. 9A is a diagram showing an example of a first model image Im1. FIG. 9A shows an example of a first model image Im1 related to the second A imaging unit Cs1.

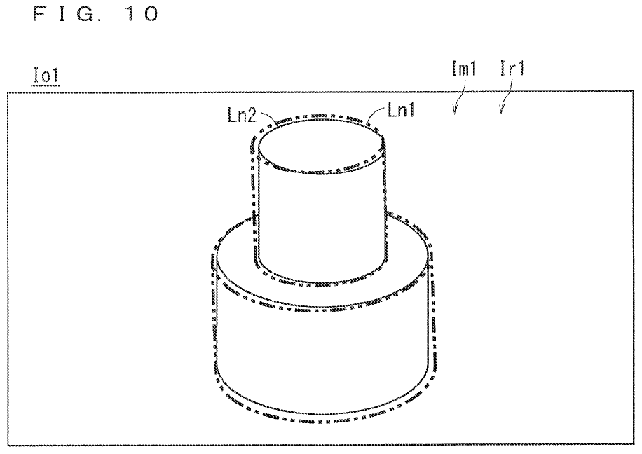

In addition, in the first preferred embodiment, the designation unit 153 can acquire, for example, a reference image related to each imaging unit 421 stored in the storage unit 14. FIG. 9B is a diagram showing an example of the reference image Ir1. FIG. 9B shows an example of a reference image Ir1 related to the second A imaging unit Cs1. FIG. 10 is a diagram showing an example of an image (also referred to as a first superimposition image) Io1 in which a first model image Im1 and a reference image Ir1 are superimposed on each other. FIG. 10 shows an example of a first superimposition image Io1 obtained by superimposing the first model image Im1 shown in FIG. 9A and the reference image Ir1 shown in FIG. 9B on each other. Here, the first model image Im1 and the reference image Ir1 are superimposed on each other such that the outer edge of the first model image Im1 coincides with the outer edge of the reference image Ir1. For example, as shown in FIG. 10, a deviation may occur between a first contour line Ln1 corresponding to the contour of the three-dimensional model 3dm in the first model image Im1 and a line (also referred to as a second contour line) Ln2 indicating a portion corresponding to the contour of the inspection object W0 captured in the reference image Ir1. In the reference image Ir1, for example, a portion corresponding to the outer edge and the corner portion of the inspection object W0 is the second contour line Ln2. Such a deviation between the first contour line Ln1 and the second contour line Ln2 may occur due to, for example, an error and the like between the design position and attitude of each imaging unit 421 and the inspection object W0, and the actual position and attitude of each imaging unit 421 and the inspection object W0 in the inspection unit 40. Specifically, examples of the error that causes the deviation include an error between the position of the design origin in the x′y′z′ coordinate system (camera coordinate system) of each imaging unit 421 and the actual second reference position P2 of each imaging unit 421, and an error between the position of the design origin in the xyz coordinate system (three-dimensional model coordinate system) and the actual first reference position P1 related to the inspection object W0. In addition, the error that causes the deviation can include, for example, an error between the design attitude of each imaging unit 421 defined by the x′y′z′ coordinate system (camera coordinate system) and the actual attitude of each imaging unit 421, an error between the design distances between origins Dv, Ds1 to Ds8, Dh1 to Dh8 of each imaging unit 421 and the actual distance between the first reference position P1 and the second reference position P2, and the like.

<<[B] Generation of Plurality of Second Model Images Im2>>

The designation unit 153 can generate each of a plurality of model images (also referred to as second model images) Im2 in which the inspection object W0 is virtually captured by the imaging unit 421 while changing the position attitude parameters related to the position and attitude of the three-dimensional model 3dm with a predetermined rule with reference to the position attitude parameters (also referred to as first position attitude parameters) used to generate the first model image Im1 for each imaging unit 421, for example. Again, for example, the imaging parameter information regarding each imaging unit 421 stored in the storage unit 14 or the like can be appropriately used.

For example, for each imaging unit 421, each of the second model images Im2 is generated while (x′, y′, z′, Rx′, Ry′, Rz′) as the position attitude parameter of the three-dimensional model 3dm in the x′y′z′ coordinate system (camera coordinate system) is changed according to a predetermined rule with the position attitude parameter (first position attitude parameter) of the three-dimensional model 3dm in the camera coordinate system used to generate the first model image Im1 as a reference. As the predetermined rule, for example, a rule in which one or more values of (x′, y′, z′, Rx′, Ry′, Rz′) as the position attitude parameters are changed little by little is adopted. Specifically, as the predetermined rule, for example, a rule in which each value of the z′ coordinate, the rotation angle Rx′, the rotation angle Ry′, and the rotation angle Rz′ is changed little by little is adopted.

For example, regarding the second A imaging unit Cs1 in the example in FIGS. 3A and 3B, (x′, y′, z′, Rx′, Ry′, Rz′)=(0, 0, Ds1, −45, 0, 90) as the first position attitude parameter related to the position and attitude of the three-dimensional model 3dm in the x′y′z′ coordinate system is used as a reference, and each of the second model images Im2 is generated while each value of the z′ coordinate, the rotation angle Rx′, the rotation angle Ry′, and the rotation angle Rz′ is changed little by little. Here, for example, an allowable range (also referred to as a distance allowable range) with respect to the reference value (for example, Ds1) for the z′ coordinate, an allowable range (also referred to as a first rotation allowable range) with respect to the reference value (for example, −45) for the rotation angle Rx′, an allowable range (also referred to as a second rotation allowable range) with respect to the reference value (for example, 0) for the rotation angle Ry′, and an allowable range (also referred to as a third rotation allowable range) with respect to the reference value (for example, 90) for the rotation angle Rz′ are set. Each of the distance allowable range, the first rotation allowable range, the second rotation allowable range, and the third rotation allowable range can be set to a relatively narrow range in advance. The distance allowable range can be set to, for example, a range or the like of about ±10 mm to ±30 mm with respect to the reference value. Each of the first rotation allowable range, the second rotation allowable range, and the third rotation allowable range can be set to a range of about ±1 (degrees) to ±3 (degrees) with respect to the reference value. Each of the distance allowable range, the first rotation allowable range, the second rotation allowable range, and the third rotation allowable range may be appropriately changeable, for example. The pitch at which the respective values of the z′ coordinate, the rotation angle Rx′, the rotation angle Ry′, and the rotation angle Rz′ are changed little by little can be set in advance. The change pitch for the z′ coordinate can be set to, for example, about 0.5 mm to 2 mm. The change pitch for each of the rotation angle Rx′, the rotation angle Ry′, and the rotation angle Rz′ can be set to, for example, about 0.1 (degrees) to 0.5 (degrees).

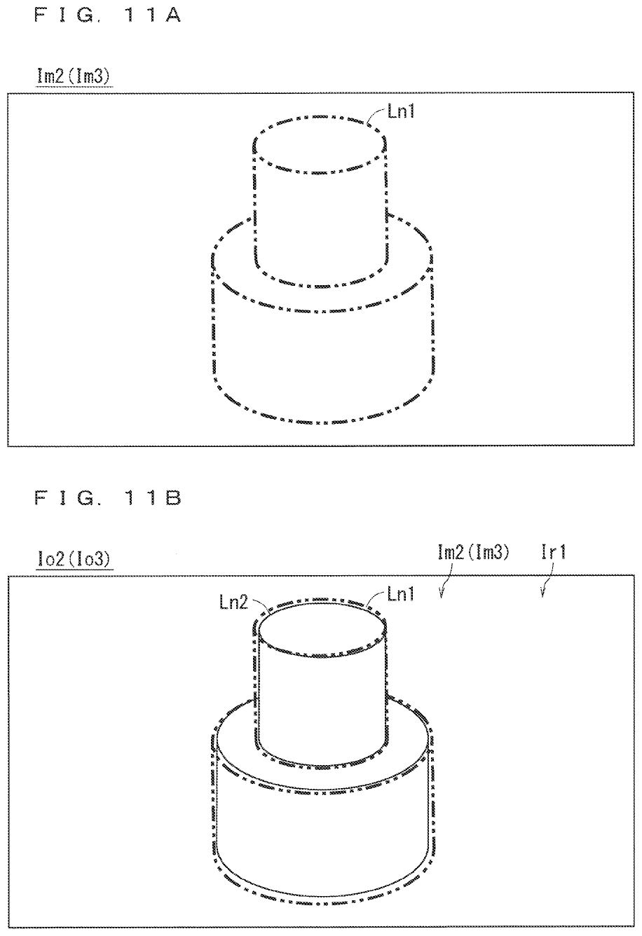

Then, for example, for each imaging unit 421, a plurality of second model images Im2 are generated based on the plurality of changed position attitude parameters related to the position and attitude of the three-dimensional models 3dm and the three-dimensional model information. Here, for example, the position and attitude of the three-dimensional model 3dm in the xyz coordinate system (three-dimensional model coordinate system) are transformed into the position and attitude in the x′y′z′ coordinate system (camera coordinate system) according to the changed position attitude parameters, and then the three-dimensional model 3dm is projected on the two-dimensional plane, whereby the second model image Im2 can be generated. Here, for example, by a method such as rendering, the three-dimensional model 3dm is projected on a two-dimensional plane with the origin of the camera coordinate system as a reference point and the z′ axis direction of the camera coordinate system as an imaging direction. At this time, for example, the imaging parameter information regarding each imaging unit 421 stored in the storage unit 14 or the like can be appropriately used. Similarly to the first model image Im1, for example, a line drawing or the like in which a portion corresponding to the contour of the three-dimensional model 3dm is drawn with a predetermined type of the first contour line Ln1 can be applied to the second model image Im2. Also in the second model image Im2, similarly to the first model image Im1, for example, a portion corresponding to the outer edge and the corner portion of the three-dimensional model 3dm is the first contour line Ln1. FIG. 11A is a diagram showing an example of a second model image Im2. FIG. 11A shows an example of a second model image Im2 related to the second A imaging unit Cs1.

<[C] Detection of One Model Image>>

For example, for each imaging unit 421, the designation unit 153 can detect one model image of the first model image Im1 and the plurality of second model images Im2 according to the matching degree between the portion corresponding to the three-dimensional model 3dm in each of the first model image Im1 and the plurality of second model images Im2 and the portion corresponding to the inspection object W0 in the reference image Ir1 obtained by imaging the inspection object W0 by the imaging unit 421.

A portion corresponding to the three-dimensional model 3dm in each of the first model image Im1 and the plurality of second model images Im2 is indicated by, for example, a first contour line Ln1 indicating a portion corresponding to the contour of the three-dimensional model 3dm. A portion corresponding to the inspection object W0 in the reference image Ir1 is indicated by, for example, a second contour line Ln2 indicating a portion corresponding to the contour of the inspection object W0. As the matching degree, for example, the degree of matching of the first contour line Ln1 with the second contour line Ln2 is applied when the reference image Ir1 and each of the first model image Im1 and the plurality of second model images Im2 are superimposed such that the outer edges of the images match each other. Here, for example, after the second contour line Ln2 in the reference image Ir1 is extracted using a Sobel filter or the like, each of the first model image Im1 and the plurality of second model images Im2 is superimposed on the reference image Ir1. FIG. 11B is a diagram showing an example of an image (also referred to as a second superimposition image) Io2 in which the reference image Ir1 and the second model image Im2 are superimposed on each other. FIG. 11B shows an example of a second superimposition image Io2 obtained by superimposing the reference image Ir1 shown in FIG. 9B and the second model image Im2 shown in FIG. 11A. Here, for example, regarding the first model image Im1, the number of pixels of a portion where the first contour line Ln1 and the second contour line Ln2 overlap in the first superimposition image Io1 can be calculated as the matching degree. In addition, for example, regarding each second model image Im2, the number of pixels of the portion where the first contour line Ln1 and the second contour line Ln2 overlap in the second superimposition image Io2 can be calculated as the matching degree.

Then, here, for each imaging unit 421, as one model image detected according to the matching degree among the first model image Im1 and the plurality of second model images Im2, for example, a mode can be considered in which a model image having the highest calculated matching degree is detected. Thus, for example, correction processing (also referred to as matching processing) for reducing the deviation between the first contour line Ln1 and the second contour line Ln2 can be achieved.

<<[D] Creation of Region Designation Information About Captured Image>>

For example, for each imaging unit 421, the designation unit 153 can create region designation information for designating the inspection image region with respect to the captured image based on the parameter (position attitude parameter) related to the position and attitude of the three-dimensional model 3dm used for generating detected one model image, the three-dimensional model information, and the inspection region information. It should be noted that, here, the position attitude parameter related to the position and attitude of the three-dimensional model 3dm used for generating the detected one model image can be said to be, for example, a position attitude parameter obtained by the matching processing described above. In addition, here, for example, a set of the three-dimensional model information and the inspection region information serves as information on the three-dimensional model 3dm in which the surface is divided into a plurality of unit inspection regions.

Here, for example, for each imaging unit 421, the position and attitude of the three-dimensional model 3dm in the xyz coordinate system (three-dimensional model coordinate system) are transformed into the position and attitude in the x′y′z′ coordinate system (camera coordinate system) according to the position attitude parameter used for generating the detected one model image, and then a plurality of unit inspection regions in the three-dimensional model 3dm are projected on a two-dimensional plane. Here, for example, by a method such as rendering, a plurality of unit inspection regions of the three-dimensional model 3dm is projected on a two-dimensional plane with the origin of the camera coordinate system as a reference point and the z′ axis direction of the camera coordinate system as an imaging direction. At this time, for example, the imaging parameter information regarding each imaging unit 421 stored in the storage unit 14 or the like can be appropriately used. In addition, at this time, for example, hidden surface erasing processing of erasing a surface hidden by a portion existing on the front surface is performed, and a plurality of image regions on which a respective plurality of unit inspection regions are projected are set in a mutually distinguishable state. As the mutually distinguishable state, for example, a state can be considered in which different colors, hatching, or the like is designated for a plurality of image regions on which a respective plurality of unit inspection regions are projected.

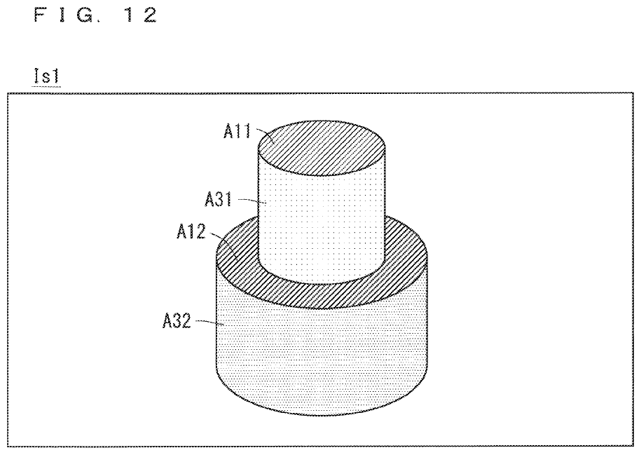

The image (also referred to as a projection image) generated by the projection is, for example, an image (also referred to as a region designation image) Is1 in which a plurality of regions (also referred to as inspection image regions) are designated in which a respective plurality of portions to be inspected corresponding to a plurality of unit inspection regions are expected to be captured in an image (captured image) that can be acquired when the inspection object W0 is imaged by the imaging unit 421. Here, for example, the region designation image Is1 serves as an example of the region designation information. FIG. 12 is a diagram showing an example of the region designation image Is1. FIG. 12 shows an example of a region designation image Is1 generated by the projection of the three-dimensional model 3dm in which the surface is divided into a plurality of regions as shown in FIG. 7C. The region designation image Is1 in FIG. 12 shows an inspection image region (also referred to as a first inspection image region) A11 corresponding to the first upper surface region Ar1a, an inspection image region (also referred to as a second inspection image region) A12 corresponding to the second upper surface region Ar1b, an inspection image region (also referred to as a third inspection image region) A31 corresponding to the first side surface region Ar3a, and an inspection image region (also referred to as a fourth inspection image region) A32 corresponding to the second side surface region Ar3b.

In this way, for example, for each imaging unit 421, even when a deviation occurs between a portion corresponding to the three-dimensional model 3dm in the first model image Im1 in which the three-dimensional model is virtually captured by the imaging unit 421 and which is generated based on the design three-dimensional model information and the design position attitude information, and a portion corresponding to the inspection object W0 in the reference image Ir1 obtained in advance by the imaging unit 421, automatic correction is performed so as to reduce the deviation, and the region designation information designating the inspection image region with respect to the captured image can be created. As a result, for example, for each imaging unit 421, a region (inspection image region) in which a portion to be inspected is expected to be captured can be efficiently designated for a captured image that can be acquired by imaging of the inspection object W0.

<1-2-2-4. Output Control Unit>

The output control unit 154 can, for example, cause the output unit 13 to output various types of information in a mode that can be recognized by the user. For example, the output control unit 154 may cause the output unit 13 to visibly output information related to the inspection image region designated by the region designation information created by the designation unit 153. For example, for each imaging unit 421, a mode is conceivable in which the region designation image Is1 as shown in FIG. 12 is displayed by the output unit 13. Thus, the user can check, for each imaging unit 421, the inspection image region designated for the captured image that can be acquired by imaging of the inspection object W0.

<1-2-2-5. Setting Unit>

For example, the setting unit 155 can set the inspection condition for the inspection image region according to the information received by the input unit 12 in response to the operation of the user in a state where the information related to the inspection image region designated by the region designation information created by the designation unit 153 is visibly output by the output unit 13. Thus, for example, for each imaging unit 421, the user can easily set the inspection condition to the inspection image region designated for the captured image that can be acquired by imaging of the inspection object W0.

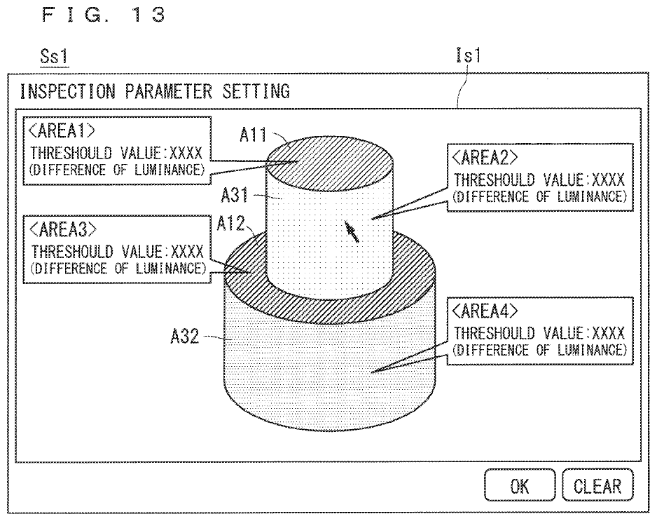

Here, for example, in a screen (also referred to as an inspection condition setting screen) Ss1 displayed by the output unit 13, a mode can be considered in which the inspection condition can be set to the inspection image region. FIG. 13 is a diagram showing an example of the inspection condition setting screen Ss1. In the example in FIG. 13, the inspection condition setting screen Ss1 includes the region designation image Is1 as shown in FIG. 12. The inspection condition setting screen Ss1 may include the region designation image Is1 as it is, or may include an image generated by performing various pieces of image processing such as trimming on the region designation image Is1. In other words, the inspection condition setting screen Ss1 has only to include, for example, information related to the inspection image region designated by the region designation information created by the designation unit 153. As the action of the user in the state where the inspection condition setting screen Ss1 is displayed, for example, the manipulation of the mouse and the keyboard included in the input unit 12 can be considered. In the example of the inspection condition setting screen Ss1 shown in FIG. 13, the user can set the inspection condition to each inspection image region by inputting the inspection condition in the balloon for each of the first inspection image region A11, the second inspection image region A12, the third inspection image region A31, and the fourth inspection image region A32 and pressing the decision button (OK button) via the input unit 12. Here, to the inspection condition, for example, a condition regarding the luminance of a captured image or the like can be applied. As the condition regarding the luminance, for example, a value indicating an allowable luminance range based on the reference image Ir1 having no defect, a value indicating an allowable area range for a different portion where the luminance is a predetermined value or more, and the like can be considered.

It should be noted that, for each of the plurality of imaging units 421, a separate inspection condition setting screen Ss1 may be displayed, or an inspection condition setting screen Ss1 including information regarding inspection image regions of two or more imaging units 421 among the plurality of imaging units 421 may be displayed.

<1-2-3. Flow of Image Processing>

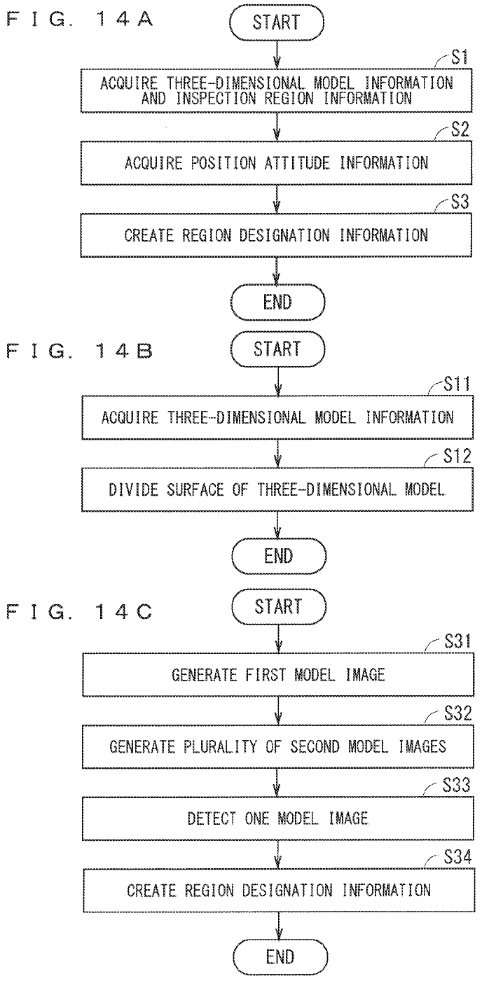

FIG. 14A is a flowchart showing an example of a flow of image processing executed by the image processing apparatus 100 along the image processing method according to the first preferred embodiment. FIG. 14B is a flowchart showing an example of a flow of processing performed in step S1 in FIG. 14A. FIG. 14C is a flowchart showing an example of a flow of processing performed in step S3 in FIG. 14A. The flow of these pieces of processing can be achieved, for example, by executing the program 14p in the arithmetic processing unit 15a. In addition, the flow of this processing is started in response to an input of a signal by the user via the input unit 12 in a state where the program 14p and the various kinds of data 14d are stored in the storage unit 14, for example. Here, for example, the processing from step S1 to step S3 shown in FIG. 14A is performed in this order. It should be noted that, for example, the processing in step S1 and the processing in step S2 may be performed in parallel, or the processing in step S1 may be performed after the processing in step S2.

In step S1 in FIG. 14A, for example, a step (also referred to as a first acquisition step) in which information (three-dimensional model information) related to the three-dimensional model of the inspection object W0 and information (inspection region information) related to the inspection region in the three-dimensional model are acquired by the first acquisition unit 151 is executed. In this step S1, for example, the processing of steps S11 and S12 shown in FIG. 14B is performed in this order.

In step S11, for example, the first acquisition unit 151 acquires the three-dimensional model information stored in the storage unit 14.

In step S12, for example, the first acquisition unit 151 acquires the inspection region information by dividing the surface of the three-dimensional model 3dm into a plurality of regions (unit inspection regions) based on the information related to the orientations of the plurality of planes constituting the three-dimensional model 3dm and the connection state of the planes in the plurality of planes. As the inspection region information, for example, information for specifying a plurality of unit inspection regions obtained by dividing the surface of the three-dimensional model 3dm of the inspection object W0 is adopted. Here, for example, performing the first region division processing and the second region division processing described above in this order divides the surface of the three-dimensional model 3dm into a plurality of regions (unit inspection regions).

In step S2, for example, a step (also referred to as a second acquisition step) of acquiring the position attitude information related to the position and attitude concerning the imaging unit 421 and the inspection object W0 in the inspection apparatus 2 is executed by the second acquisition unit 152. Here, for example, the second acquisition unit 152 acquires the position attitude information stored in the storage unit 14. To the position attitude information, for example, design information or the like can be applied that makes clear a relative positional relationship, a relative angular relationship, a relative attitudinal relationship, and the like between the inspection object W0 held in a desired attitude by the holding unit 41 of the inspection unit 40, and each imaging unit 421 of the inspection unit 40. For example, the position attitude information may include information on coordinates of a reference position (first reference position) P1 of a region where the inspection object W0 is disposed in the inspection unit 40, information on coordinates of a reference position (second reference position) P2 for each imaging unit 421, information on an xyz coordinate system (three-dimensional model coordinate system) having a reference point corresponding to the first reference position P1 as an origin, information on an x′y′z′ coordinate system (camera coordinate system) having a reference point corresponding to the second reference position P2 for each imaging unit 421 as an origin, and the like.

In step S3, for example, a step (also referred to as a designation step) of creating region designation information for designating the inspection image region corresponding to the inspection region for the captured image that can be acquired by the imaging of the inspection object W0 by the imaging unit 421 based on the three-dimensional model information and the inspection region information acquired in step S1 and the position attitude information acquired in step S2, is executed by the designation unit 153. In this step S3, for example, the processing from step S31 to step S34 shown in FIG. 14C is performed in this order.

In step S31, for example, the designation unit 153 generates the first model image Im1 in which the inspection object W0 is virtually captured by each imaging unit 421 based on the three-dimensional model information and the position attitude information.

In step S32, for example, the designation unit 153 generates, for each imaging unit 421, a plurality of second model images Im2 in which the inspection object W0 is virtually captured by the imaging unit 421 respectively while the parameter (position attitude parameter) related to the position and attitude of the three-dimensional model 3dm is changed by a predetermined rule with the position attitude parameter (first position attitude parameter) used to generate the first model image Im1 as a reference.

In step S33, for example, for each imaging unit 421, the designation unit 153 detects one model image of the first model image Im1 and the plurality of second model images Im2 according to the matching degree between the portion corresponding to the three-dimensional model 3dm in each of the first model image Im1 and the plurality of second model images Im2 and the portion corresponding to the inspection object W0 in the reference image Ir1 obtained by imaging the inspection object W0 by the imaging unit 421. For example, when the reference image Ir1, and each of the first model image Im1 and the plurality of second model images Im2 are superimposed such that the outer edges of the images coincide with each other, the degree of matching of the first contour line Ln1 with the second contour line Ln2 is calculated as the matching degree. Then, for example, a model image having the highest calculated matching degree among the first model image Im1 and the plurality of second model images Im2 can be detected as one model image.

In step S34, for example, the designation unit 153 creates region designation information for designating the inspection image region for the captured image that can be acquired by the imaging of the inspection object W0 by the imaging unit 421 based on the parameters (position attitude parameters) related to the position and attitude of the three-dimensional model 3dm used to generate the detected one model image, and the three-dimensional model information and the inspection region information for each imaging unit 421. Here, for example, for each imaging unit 421, the position and attitude of the three-dimensional model 3dm in the xyz coordinate system (three-dimensional model coordinate system) are transformed into the position and attitude in the x′y′z′ coordinate system (camera coordinate system) according to the position attitude parameter used to generate the detected one model image by the designation unit 153, and then a plurality of unit inspection regions in the three-dimensional model 3dm are projected on a two-dimensional plane by the designation unit 153, whereby the region designation image Is1 as shown in FIG. 12 is generated as an example of the region designation information. In the region designation image Is1, for example, a plurality of inspection image regions are designated in which a respective plurality of portions to be inspected corresponding to a plurality of unit inspection regions are expected to be captured in a captured image that can be acquired when the imaging unit 421 images the inspection object W0.

### 1-3. Summary of First Preferred Embodiment

As described above, according to the image processing apparatus 100 and the image processing method according to the first preferred embodiment, for example, for each imaging unit 421, even when a deviation occurs between a portion corresponding to the three-dimensional model 3dm in the first model image Im1 in which the three-dimensional model 3dm is virtually captured by the imaging unit 421 and which is generated based on the design three-dimensional model information and the design position attitude information, and a portion corresponding to the inspection object W0 in the reference image Ir1 obtained in advance by the imaging unit 421, automatic correction is performed so as to reduce the deviation, and the region designation information designating the inspection image region with respect to the captured image can be created. As a result, for example, for each imaging unit 421, an inspection image region in which a portion to be inspected is expected to be captured can be efficiently designated for a captured image that can be acquired by imaging of the inspection object W0.

### 2. Other Preferred Embodiments

The present invention is not limited to the above-described preferred embodiment, and various changes and improvements can be made in a scope without departing from the gist of the present invention.

### 2-1. Second Preferred Embodiment

In the first preferred embodiment, for example, the designation unit 153 automatically performs four-stage processing ([A] generation of first model image Im1, [B] generation of a plurality of second model images Im2, [C] detection of one model image, and [D] creation of region designation information about captured image) on each imaging unit 421, but the present invention is not limited thereto. For example, matching processing for reducing the deviation between the first contour line Ln1 and the second contour line Ln2 achieved in the second-stage processing ([B] generation of a plurality of second model images Im2) and the third-stage processing ([C] detection of one model image) may be performed according to the user's action. In other words, the designation unit 153 may perform matching processing (also referred to as manual matching processing) corresponding to the action of the user.

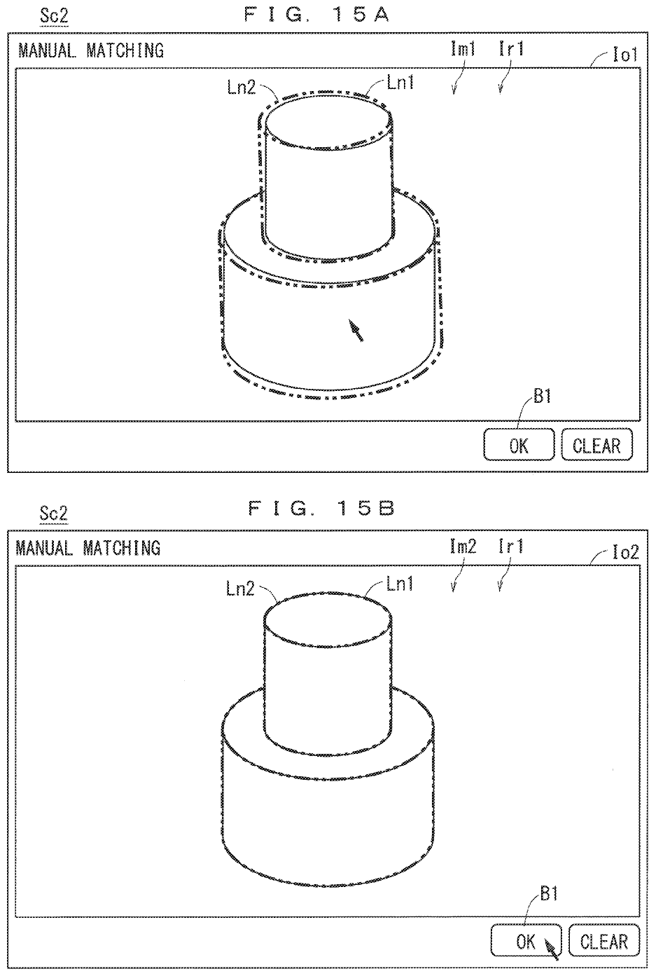

In this case, for example, a mode is conceivable in which the manual matching processing corresponding to the action of the user is achieved by a screen (also referred to as a manual matching screen) visibly output by the output unit 13. FIGS. 15A and 15B are diagrams each illustrating a manual matching screen Sc2 according to the second preferred embodiment.

Here, for example, first, similarly to the first-stage processing ([A] generation of the first model image Im1) described above, the designation unit 153 generates the first model image Im1 in which the inspection object W0 is virtually captured by the imaging unit 421 based on the three-dimensional model information and the position attitude information. At this time, for example, the output unit 13 visibly outputs an image (first superimposition image) Io1 obtained by superimposing the reference image Ir1 obtained by the imaging of the inspection object W0 by the imaging unit 421 and the first model image Im1. For example, as shown in FIG. 15A, the output unit 13 displays the manual matching screen Sc2 in the initial state including the image related to the first superimposition image Io1 obtained by superimposing the reference image Ir1 and the first model image Im1. Here, the first model image Im1 and the reference image Ir1 are superimposed on each other such that the outer edge of the first model image Im1 coincides with the outer edge of the reference image Ir1. In the manual matching screen Sc2 in the initial state, for example, there may be a deviation between a portion corresponding to the inspection object W0 in the reference image Ir1 and a portion corresponding to the three-dimensional model 3dm in the first model image Im1. In other words, for example, a deviation may occur between a first contour line Ln1 corresponding to the contour of the three-dimensional model 3dm in the first model image Im1 and a second contour line Ln2 indicating a portion corresponding to the contour of the inspection object W0 captured in the reference image Ir1.

In this case, for example, the manual matching processing can be achieved by the manual matching screen Sc2. in the manual matching screen Sc2, for example, with respect to the second contour line Ln2 indicating the portion corresponding to the contour of the inspection object W0 captured in the reference image Ir1, with reference to the first contour line Ln1 indicating the portion corresponding to the contour of the three-dimensional model 3dm in the first model image Im1, the user moves the first contour line Ln1 through the input unit 12 by rotation, enlargement, reduction, and the like, whereby the deviation can be reduced. Here, for example, the designation unit 153 sequentially generates a plurality of second model images Im2 in which the inspection object W0 is virtually captured by the imaging unit 421 respectively while changing the position attitude parameter related to the position and attitude of the three-dimensional model 3dm with reference to the position attitude parameter (first position attitude parameter) used to generate the first model image Im1 according to the information accepted by the input unit 12 in response to the action of the user. At this time, for example, a mode is conceivable in which each value of the z′ coordinate, the rotation angle Rx′, the rotation angle Ry′, and the rotation angle Rz′ of the (x′, y′, z′, Rx′, Ry′, Rz′) as the position attitude parameters can be changed according to the information accepted by the input unit 12 in response to the action of the user. Specifically, for example, in the manual matching screen Sc2, according to the manipulation of the mouse of the input unit 12 by the user, the mouse pointer is moved in the region surrounded by the first contour line Ln1, and the first contour line Ln1 is designated by the left click, whereby a state is made where the first contour line Ln1 can be moved by rotation, enlargement, reduction, and the like (also referred to as a movable state). Here, for example, a mode is conceivable in which processing of setting the movable state and processing of releasing the movable state are performed each time the left click in the mouse manipulation by the user is performed. In the movable state, for example, a mode is conceivable in which the value of the rotation angle Rx′ can be changed according to the vertical movement of the mouse, the value of the rotation angle Ry′ can be changed according to the horizontal movement of the mouse, the value of the rotation angle Rz′ can be changed by the change (rotation) of the angle of the mouse on the plane, and the value of the z′ coordinate can be changed by the rotation of the wheel of the mouse. Here, for example, every time at least one value of the z′ coordinate, the rotation angle Rx′, the rotation angle Ry′, and the rotation angle Rz′ in the position attitude parameter is changed, the second model image Im2 is generated using the changed position attitude parameter.

Here, for example, every time each of the plurality of second model images Im2 is newly generated by the designation unit 153, the output unit 13 visibly outputs a superimposition image (second superimposition image) lot in which the reference image Ir1 and the newly generated second model image Im2 are superimposed. FIG. 15B shows a manual matching screen Sc2 including an image related to the second superimposition image Io2 in which the reference image Ir1 and the second model image Im2 are superimposed. Here, the second model image Im2 and the reference image Ir1 are superimposed on each other such that the outer edge of the second model image Im2 coincides with the outer edge of the reference image Ir1. In the example of the manual matching screen Sc2 in FIG. 15B, a portion corresponding to the inspection object W0 in the reference image Ir1 and a portion corresponding to the three-dimensional model 3dm in the second model image Im2 substantially coincide with each other. In other words, the example of the manual matching screen Sc2 in FIG. 15B shows a state where the first contour line Ln1 corresponding to the contour of the three-dimensional model 3dm in the second model image Im2 and the second contour line Ln2 indicating the portion corresponding to the contour of the inspection object W0 captured in the reference image Ir1 substantially coincide with each other. In the manual matching screen Sc2, for example, with reference to the initial state shown in FIG. 15A, the user matches the first contour line Ln1 with the second contour line Ln2 as shown in FIG. 15B while moving the first contour line Ln1 with respect to the fixed second contour line Ln2 by rotation, enlargement, reduction, and the like, whereby the manual matching processing can be achieved.

Then, for example, in response to the information accepted by the input unit 12 in response to the specific action of the user, the designation unit 153 designates the inspection image region for the captured image based on the position attitude parameters related to the position and attitude of the three-dimensional model 3dm used to generate one second model image Im2 superimposed on the reference image Ir1 when generating the second superimposition image Io2 visibly output by the output unit 13 among the plurality of second model images Im2, the three-dimensional model information, and the inspection region information. Here, examples of the specific action of the user include pressing with the mouse pointer of the OK button B1 as a predetermined button on the manual matching screen Sc2 in a state where the movable state is released. Then, here, for example, the position and attitude of the three-dimensional model 3dm in the xyz coordinate system (three-dimensional model coordinate system) are transformed into the position and attitude in the x′y′z′ coordinate system (camera coordinate system) according to the position attitude parameter used for generating one second model image Im2 superimposed on the reference image Ir1 when generating the second superimposition image Io2 displayed on the manual matching screen Sc2 by the designation unit 153, and then, a plurality of unit inspection regions in the three-dimensional model 3dm are projected on a two-dimensional plane by the designation unit 153, whereby the region designation image Is1 as shown in FIG. 12 is generated as an example of the region designation information. Here, for example, by a method such as rendering, a plurality of unit inspection regions of the three-dimensional model 3dm is projected on a two-dimensional plane with the origin of the camera coordinate system as a reference point and the z′ axis direction of the camera coordinate system as an imaging direction. At this time, for example, the imaging parameter information regarding each imaging unit 421 stored in the storage unit 14 or the like can be appropriately used. In addition, at this time, for example, hidden surface erasing processing of erasing a surface hidden by a portion existing on the front surface is performed, and a plurality of image regions on which a respective plurality of unit inspection regions are projected are set in a mutually distinguishable state. Here, among the plurality of second model images Im2, the position attitude parameters related to the position and attitude of the three-dimensional model 3dm used for generating the second model image Im2 superimposed on the reference image Ir1 in the generation of the second superimposition image Io2 visibly output by the output unit 13 when the user performs a specific action can be said to be, for example, position attitude parameters obtained by the matching processing.

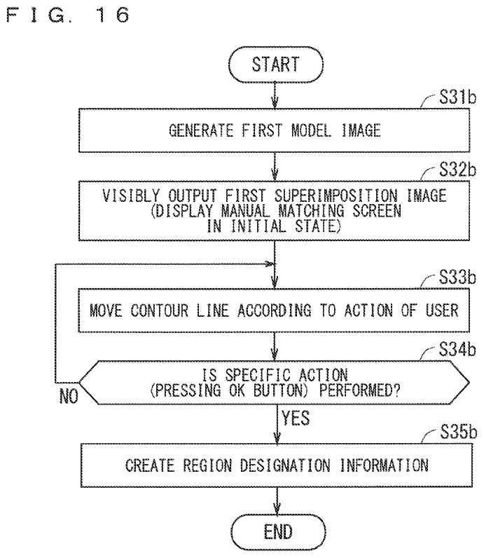

When such a configuration is adopted, for example, in the designation step (step S3) in FIG. 14A, the processing from step S31b to step S35b shown in FIG. 16 can be performed.

In step S31b, for example, the designation unit 153 generates the first model image Im1 in which the inspection object W0 is virtually captured by the imaging unit 421 based on the three-dimensional model information and the position attitude information.

In step S32b, for example, the output unit 13 visibly outputs the first superimposition image Io1 obtained by superimposing the reference image Ir1 obtained by imaging the inspection object W0 in advance by the imaging unit 421 and the first model image Im1 generated in step S31b. Here, for example, the output unit 13 displays the manual matching screen Sc2 in the initial state including the image related to the first superimposition image Io1 in which the reference image Ir1 and the first model image Im1 are superimposed.

In step S33b, for example, the designation unit 153 sequentially generates a plurality of second model images Im2 in which the inspection object W0 is virtually captured by the imaging unit 421 respectively while changing the position attitude parameter related to the position and attitude of the three-dimensional model 3dm with reference to the first position attitude parameter used to generate the first model image Im1 according to the information accepted by the input unit 12 in response to the action of the user. At this time, for example, every time each of the plurality of second model images Im2 is newly generated, the second superimposition image Io2 in which the reference image Ir1 and the newly generated second model image Im2 are superimposed is visibly output by the output unit 13. Here, for example, the user can temporally sequentially switch the first contour line Ln1 corresponding to the contour of the three-dimensional model 3dm in the first model image Im1 as an initial state to the first contour line Ln1 corresponding to the contour of the three-dimensional model 3dm in the newly generated second model image Im2 with respect to the fixed second contour line Ln2 indicating the portion corresponding to the contour of the inspection object W0 captured in the reference image Ir1 on the manual matching screen Sc2 displayed by the output unit 13 by the input of the information via the input unit 12. In other words, in the manual matching screen Sc2, for example, the first contour line Ln1 can be moved by rotation, enlargement, reduction, and the like to the fixed second contour line Ln2. Thus, for example, manual matching processing is executed.

In step S34b, for example, the designation unit 153 determines whether or not a specific action has been performed by the user. Here, for example, if the specific action is not performed by the user, the processing returns to step S33b, and if the specific action is performed by the user, the processing proceeds to step S35b in response to the information accepted by the input unit 12 in response to the specific action by the user. Here, for example, pressing of the OK button B1 as a predetermined button on the manual matching screen Sc2 with a mouse pointer is applied to the specific action of the user.

In step S35b, for example, the region designation information for designating the inspection image region for the captured image is created by the designation unit 153 based on the position attitude parameter related to the position and attitude of the three-dimensional model 3dm used to generate one second model image Im2 superimposed on the reference image Ir1 when generating the second superimposition image Io2 visibly output by the output unit 13 among the plurality of second model images Im2, the three-dimensional model information, and the inspection region information. Here, for example, the position and attitude of the three-dimensional model 3dm in the xyz coordinate system (three-dimensional model coordinate system) are transformed into the position and attitude in the x′y′z′ coordinate system (camera coordinate system) according to the position attitude parameter used for generating one second model image Im2 superimposed on the reference image Ir1 when generating the second superimposition image Io2 displayed on the manual matching screen Sc2 by the designation unit 153, and then, a plurality of unit inspection regions in the three-dimensional model 3dm are projected on a two-dimensional plane by the designation unit 153, whereby the region designation image Is1 as shown in FIG. 12 is generated as an example of the region designation information.

According to the image processing apparatus 100 and the image processing method according to the second preferred embodiment as described above, for example, for each imaging unit 421, even when a deviation occurs between a portion corresponding to the three-dimensional model 3dm in the first model image Im1 which is generated based on the design three-dimensional model information and the design position attitude information and in which the imaging unit 421 virtually captures the three-dimensional model 3dm, and a portion corresponding to the inspection object W0 in the reference image Ir1 obtained in advance by imaging of the inspection object W0 by the imaging unit 421, the correction is manually performed so as to reduce the deviation, and the region designation information for designating the inspection image region can be created for the captured image. As a result, for example, for each imaging unit 421, an inspection image region in which a portion to be inspected is expected to be captured can be efficiently designated for a captured image that can be acquired by imaging of the inspection object W0.

### 2-2. Third Preferred Embodiment

In the first preferred embodiment, the matching processing is automatically performed, and in the second preferred embodiment, the matching processing is manually performed, but the present invention is not limited thereto. For example, after the matching processing is manually performed, the matching processing may be further automatically performed. For example, among the four-stage processing ([A] generation of first model image Im1, [B] generation of a plurality of second model images Im2, [C] detection of one model image, and [D] creation of region designation information about captured image) for each imaging unit 421 performed by the designation unit 153 in the first preferred embodiment, instead of the automatic matching processing of reducing the deviation between the first contour line Ln1 and the second contour line Ln2 achieved by the second-stage processing ([B] generation of a plurality of second model images Im2) and the third-stage processing ([C] detection of one model image), manual matching processing corresponding to the action of the user and subsequent automatic matching processing may be performed. In this case, for example, a mode is conceivable in which manual matching processing corresponding to the action of the user is achieved based on a screen (manual matching screen) visibly output by the output unit 13 as in the second preferred embodiment, and automatic matching processing similar to that of the first preferred embodiment is further performed.

Specifically, first, the designation unit 153 generates the first model image Im1 in which the inspection object W0 is virtually captured by the imaging unit 421 based on the three-dimensional model information and the position attitude information. At this time, for example, the output unit 13 visibly outputs an image (first superimposition image) Io1 obtained by superimposing the reference image Ir1 obtained by the imaging of the inspection object W0 by the imaging unit 421 and the first model image Im1. Here, for example, as shown in FIG. 15A, the output unit 13 displays the manual matching screen Sc2 in the initial state including the image related to the first superimposition image Io1 obtained by superimposing the reference image Ir1 and the first model image Im1.

In the manual matching screen Sc2, for example, the manual correction can be achieved to reduce the deviation occurring between the portion corresponding to the inspection object W0 in the reference image Ir1 and the portion corresponding to the three-dimensional model 3dm in the first model image Im1. In other words, in the manual matching screen Sc2, for example, the manual correction can be achieved that reduces the deviation between the first contour line Ln1 corresponding to the contour of the three-dimensional model 3dm in the first model image Im1 and the second contour line Ln2 indicating the portion corresponding to the contour of the inspection object W0 captured in the reference image Ir1. For example, the user moves the first contour line Ln1 by rotation, enlargement, reduction, or the like via the input unit 12 with respect to the second contour line Ln2 with reference to the first contour line Ln1 related to the initial state, whereby the deviation can be reduced. Here, for example, the designation unit 153 sequentially generates a plurality of second model images Im2 in which the inspection object W0 is virtually captured by the imaging unit 421 respectively while changing the position attitude parameter related to the position and attitude of the three-dimensional model 3dm with reference to the position attitude parameter (first position attitude parameter) used to generate the first model image Im1 according to the information accepted by the input unit 12 in response to the action of the user. More specifically, for example, every time at least some of the numerical values (z′ coordinate, rotation angle Rx′, rotation angle Ry′, rotation angle Rz′, and the like) of the (x′, y′, z′, Rx′, Ry′, Rz′) as the position attitude parameters are changed according to the information accepted by the input unit 12 in response to the action of the user, the second model image Im2 is generated using the changed position attitude parameters. At this time, for example, every time each of the plurality of second model images Im2 is newly generated by the designation unit 153, the output unit 13 visibly outputs a superimposition image (second superimposition image) Io2 in which the reference image Ir1 and the newly generated second model image Im2 are superimposed. More specifically, in the manual matching screen Sc2, for example, with reference to the initial state shown in FIG. 15A, the user matches the first contour line Ln1 with the second contour line Ln2 as shown in FIG. 15B while moving the first tour line Ln1 with respect to the fixed second contour line Ln2 by rotation, enlargement, reduction, and the like, whereby the manual matching processing can be achieved.

Here, for example, in response to the information accepted by the input unit 12 in response to the specific action of the user, the designation unit 153 generates a plurality of model images (also referred to as third model images) Im3 in which the inspection object W0 is virtually captured by the imaging unit 421 respectively while changing the position attitude parameters related to the position and attitude of the three-dimensional model 3dm by a predetermined rule with reference to the position attitude parameters (also referred to as second position attitude parameters) related to the position and attitude of the three-dimensional model 3dm used for generating one second model image (reference second model image) Im2 superimposed on the reference image Ir1 when generating the second superimposition image Io2 visibly output by the output unit 13 among the plurality of second model images Im2. Here, for example, for each imaging unit 421, a plurality of third model images Im3 are generated based on the position attitude parameters related to the position and attitude of the plurality of changed three-dimensional models 3dm and the three-dimensional model information. More specifically, for example, the position and attitude of the three-dimensional model 3dm in the xyz coordinate system (three-dimensional model coordinate system) are transformed into the position and attitude in the x′y′z′ coordinate system (camera coordinate system) according to the changed position attitude parameters, and then the three-dimensional model 3dm is projected on the two-dimensional plane, whereby the third model image Im3 can be generated. For example, as shown in FIG. 11A, similarly to the first model image Im1 and the second model image Im2, a line drawing or the like in which a portion corresponding to the contour of the three-dimensional model 3dm is drawn with a predetermined type of the first contour line Ln1 can be applied to the third model image Im3. Here, for example, by a method such as rendering, the three-dimensional model 3dm is projected on a two-dimensional plane with the origin of the camera coordinate system as a reference point and the z′ axis direction of the camera coordinate system as an imaging direction. At this time, for example, the imaging parameter information regarding each imaging unit 421 stored in the storage unit 14 or the like can be appropriately used. In the third preferred embodiment, for example, by performing the manual matching processing described above, the deviation between the first contour line Ln1 corresponding to the contour of the three-dimensional model 3dm and the second contour line Ln2 indicating a portion corresponding to the contour of the inspection object W0 captured in the reference image Ir1 is already reduced to some extent. Therefore, for example, the range in which the position attitude parameter is changed may be set narrower than that in the example of the first preferred embodiment. Specifically, for example, each of the distance allowable range, the first rotation allowable range, the second rotation allowable range, and the third rotation allowable range may be set narrower than that in the example of the first preferred embodiment.

In addition, here, for example, for each imaging unit 421, the designation unit 153 detects one model image of one second model image (reference second model image) Im2 and a plurality of third model images Im3 according to the matching degree between the portion corresponding to the three-dimensional model 3dm in each of one second model image (reference second model image) Im2 and the plurality of third model images Im3 and the portion corresponding to the inspection object W0 in the reference image Ir1 obtained by imaging the inspection object W0 by the imaging unit 421. As the matching degree, for example, as shown in FIG. 11B, the degree of matching of the first contour line Ln1 with the second contour line Ln2 is applied when the reference image Ir1 and each of the reference second model image Im2 and the plurality of third model images Im3 are superimposed such that the outer edges of the images match each other. Here, for example, after the second contour line Ln2 in the reference image Ir1 is extracted using a Sobel filter or the like, each of the reference second model image Im2 and the plurality of third model images Im3 is superimposed on the reference image Ir1. For example, as shown in FIG. 11B, an image (also referred to as a third superimposition image) Io3 in which the reference image Ir1 and the third model image Im3 are superimposed is generated. Here, for example, regarding the reference second model image Im2, the number of pixels of a portion where the first contour line Ln1 and the second contour line Ln2 overlap in the second superimposition image Io2 can be calculated as the matching degree. In addition, for example, regarding each third model image Im3, the number of pixels of the portion where the first contour line Ln1 and the second contour line Ln2 overlap in the third superimposition image Io3 can be calculated as the matching degree. Then, here, for each imaging unit 421, for example, a model image having the highest calculated matching degree can be detected as one model image detected according to the matching degree among the reference second model image Im2 and the plurality of third model images 1m3. Thus, for example, automatic correction processing (automatic matching processing) for reducing the deviation between the first contour line Ln1 and the second contour line Ln2 can be achieved.

Then, for example, for each imaging unit 421, the designation unit 153 creates region designation information for designating the inspection image region for the captured image based on the parameters (position attitude parameters) related to the position and attitude of the three-dimensional model 3dm used to generate the detected one model image, the three-dimensional model information, and the inspection region information. Here, for example, the position and attitude of the three-dimensional model 3dm in the xyz coordinate system (three-dimensional model coordinate system) are transformed into the position and attitude in the x′y′z′ coordinate system (camera coordinate system) according to the position attitude parameter used to generate the detected one model image by the designation unit 153, and then a plurality of unit inspection regions in the three-dimensional model 3dm are projected on a two-dimensional plane by the designation unit 153, whereby the region designation image Is1 as shown in FIG. 12 is generated as an example of the region designation information. Here, for example, by a method such as rendering, a plurality of unit inspection regions of the three-dimensional model 3dm is projected on a two-dimensional plane with the origin of the camera coordinate system as a reference point and the z′ axis direction of the camera coordinate system as an imaging direction. At this time, for example, the imaging parameter information regarding each imaging unit 421 stored in the storage unit 14 or the like can be appropriately used. In addition, at this time, for example, hidden surface erasing processing of erasing a surface hidden by a portion existing on the front surface is performed, and a plurality of image regions on which a respective plurality of unit inspection regions are projected are set in a mutually distinguishable state. Here, the position attitude parameter related to the position and attitude of the three-dimensional model 3dm used for generating the detected one model image can be said to be, for example, a position attitude parameter obtained by the matching processing.

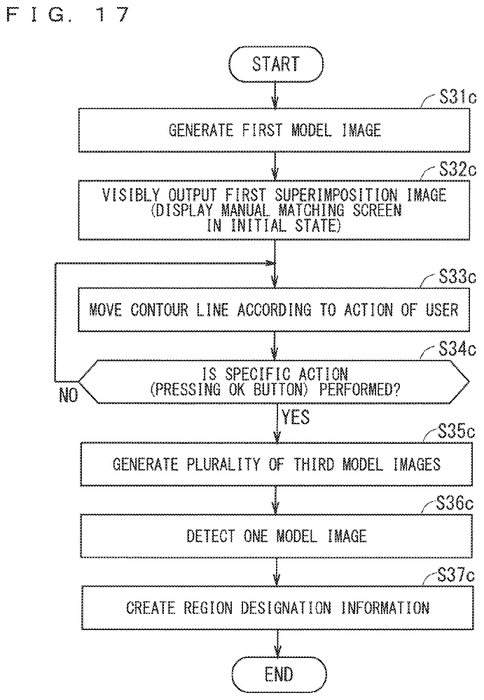

When such a configuration is adopted, for example, in the designation step (step S3) in FIG. 14A, the processing from step S31c to step S37c shown in FIG. 17 can be performed.

In step S31c, for example, processing similar to step S31b in FIG. 16 is performed. In step S32c, for example, processing similar to step S32b in FIG. 16 is performed. In step S33c, for example, processing similar to step S33b in FIG. 16 is performed.

In step S34c, as in step S34b in FIG.16, for example, the designation unit 153 determines whether or not a specific action has been performed by the user. Here, for example, if the specific action is not performed by the user, the processing returns to step S33c, and if the specific action is performed by the user, the processing proceeds to step S35c in response to the information accepted by the input unit 12 in response to the specific action by the user. Here, for example, pressing of the OK button B1 as a predetermined button on the manual matching screen Sc2 with a mouse pointer is applied to the specific action of the user.

In step S35c, for example, the designation unit 153 generates each of a plurality of model images (third model images) Im3 in which the inspection object W0 is virtually captured by the imaging unit 421 respectively while the position attitude parameters related to the position and attitude of the three-dimensional model 3dm are changed by a predetermined rule, with reference to the position attitude parameters (second position attitude parameters) related to the position and attitude of the three-dimensional model 3dm used for generating one second model image (reference second model image) Im2 superimposed on the reference image Ir1 when generating the second superimposition image Io2 visibly output by the output unit 13 among the plurality of second model images Im2 generated in step S33c.

In step S36c, for example, for each imaging unit 421, the designation unit 153 detects one model image of one second model image (reference second model image) Im2 and a plurality of third model images Im3 according to the matching degree between the portion corresponding to the three-dimensional model 3dm in each of one second model image (reference second model image) Im2 and the plurality of third model images Im3 and the portion corresponding to the inspection object W0 in the reference image Ir1 obtained by imaging the inspection object W0 by the imaging unit 421. Here, for example, when the reference image Ir1 and each of one reference second model image Im2 and the plurality of third model images Im3 are superimposed such that the outer edges of the images coincide with each other, a model image having the highest degree of matching (matching degree) of the first contour line Ln1 with respect to the second contour line Ln2 among the reference second model image Im2 and the plurality of third model images Im3 is detected as one model image.

In step S37c, for example, for each imaging unit 421, the designation unit 153 creates region designation information for designating the inspection image region for the captured image based on the position attitude parameters related to the position and attitude of the three-dimensional model 3dm used to generate one model image detected in step S36c, the three-dimensional model information, and the inspection region information. Here, for example, for each imaging unit 421, the position and attitude of the three-dimensional model 3dm in the xyz coordinate system (three-dimensional model coordinate system) are transformed into the position and attitude in the x′y′z′ coordinate system (camera coordinate system) according to the position attitude parameter used to generate the one model image detected in step S36c by the designation unit 153, and then a plurality of unit inspection regions in the three-dimensional model 3dm are projected on a two-dimensional plane by the designation unit 153, whereby the region designation image Is1 as shown in FIG. 12 is generated as an example of the region designation information.

According to the image processing apparatus 100 and the image processing method according to the third preferred embodiment, for example, for each imaging unit 421, manual and automatic corrections are sequentially performed so as to reduce a deviation occurring between a portion corresponding to the three-dimensional model 3dm in the first model image Im1 which is generated based on the design three-dimensional model information and the position attitude information and in which the imaging unit 421 virtually captures the three-dimensional model 3dm and a portion corresponding to the inspection object W0 in the reference image Ir1 obtained in advance by imaging the inspection object W0 by the imaging unit 421, and the region designation information for designating the inspection image region for the captured image can be created. Thus, for example, when reduction of the deviation is insufficient by manual correction, the deviation can be reduced by further automatic correction. As a result, for example, for each imaging unit 421, an inspection image region in which a portion to be inspected is expected to be captured can be efficiently designated for a captured image that can be acquired by imaging of the inspection object W0.

### 2-3. Fourth Preferred Embodiment

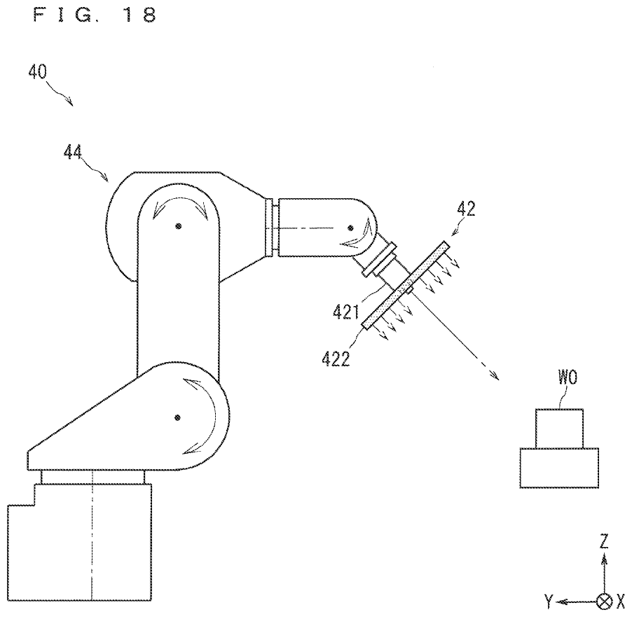

In each of the above preferred embodiments, for example, the inspection unit 40 includes a plurality of imaging units 421, but the present invention is not limited thereto. The inspection unit 40 may include, for example, one or more imaging units 421. Here, instead of including a plurality of imaging units 421 fixed at a plurality of mutually different positions and attitudes, the inspection unit 40 may include, for example, as shown in FIG. 18, a moving mechanism 44 capable of moving the imaging unit 421 so that the position and attitude of the imaging unit 421 come to a plurality of mutually different positions and attitudes. FIG. 18 is a diagram showing a configuration example of the inspection unit 40 according to the fourth preferred embodiment. In FIG. 18, illustration of the holding unit 41 is omitted for convenience. In the example in FIG. 18, the inspection unit 40 includes an imaging module 42 and a moving mechanism 44. The moving mechanism 44 is fixed to, for example, a housing or the like of the inspection unit 40. The moving mechanism 44 can change, for example, the relative position and attitude of the imaging module 42 with respect to the inspection object W0. For example, a robot arm or the like is applied to the moving mechanism 44. For example, a six-axis robot arm or the like is applied to the robot arm. The imaging module 42 is fixed to a tip of a robot arm, for example. Thus, for example, the moving mechanism 44 can move the imaging module 42 so that the position and attitude of the imaging module 42 come to a plurality of mutually different positions and attitudes. When such a configuration is adopted, the image processing for the plurality of imaging units 421 in each of the above preferred embodiments may be image processing for a plurality of positions and attitudes in one imaging unit 421.

### 2-4. Fifth Preferred Embodiment

In each of the above preferred embodiments, for example, the matching processing is performed for each of the imaging units 421 arranged at a plurality of positions and attitudes, but the present invention is not limited thereto. For example, the matching processing may be performed on the imaging unit 421 arranged at some positions and attitudes of the plurality of positions and attitudes, in this case, for example, for the imaging unit 421 arranged at the remaining position and attitude except for some positions and attitudes among the plurality of positions and attitudes, the designation unit 153 may create region designation information for designating the inspection image region corresponding to the inspection region for the captured image that can be acquired by imaging of the inspection object W0 by the imaging unit 421 based on the position attitude parameter obtained by the matching processing for the imaging unit 421 arranged at some positions and attitudes and the information regarding the relative relationship with respect to the plurality of positions and attitudes of the imaging unit 421 included in the position attitude information. When such a configuration is adopted, for example, for each imaging unit 421, an inspection image region in which a portion to be inspected is expected to be captured can be efficiently designated for a captured image that can be acquired by imaging of the inspection object W0.

Here, for example, in the examples in FIGS. 3A and 3B, the position attitude parameter obtained by the matching processing for the imaging unit 421 of one second imaging module 42s of the eight second imaging modules 42s is set as a reference position attitude parameter (also referred to as a first reference position attitude parameter). Then, based on the first reference position attitude parameter and the information regarding the relative position and attitude for the eight second imaging modules 42s, for each imaging unit 421 of the remaining seven second imaging modules 42s among the eight second imaging modules 42s, region designation information for designating the inspection image region corresponding to the inspection region for the captured image that can be acquired by imaging of the inspection object W0 by the imaging unit 421 may be created. Specifically, for example, by changing the value of the rotation angle Rz′ in the first reference position attitude parameter by 45 (degrees), the position attitude parameter for projecting a plurality of unit inspection regions in the three-dimensional model 3dm on the two-dimensional plane can be calculated for each imaging unit 421 of the remaining seven second imaging modules 42s. Thus, for example, for each imaging unit 421 of the eight second imaging modules 42s, an inspection image region in which a portion to be inspected is expected to be captured can be efficiently designated for a captured image that can be acquired by imaging of the inspection object W0.

In addition, for example, in the examples in FIGS. 3A and 3B, the position attitude parameter obtained by the matching processing for the imaging unit 421 of one third imaging module 42h of the eight third imaging modules 42h is set as a reference position attitude parameter (also referred to as a second reference position attitude parameter). Then, based on the second reference position attitude parameter and the information regarding the relative position and attitude for the eight third imaging modules 42h, for each imaging unit 421 of the remaining seven third imaging modules 42h among the eight third imaging modules 42h, region designation information for designating the inspection image region corresponding to the inspection region for the captured image that can be acquired by imaging of the inspection object W0 by the imaging unit 421 may be created. Specifically, for example, by changing the value of the rotation angle Rz′ in the second reference position attitude parameter by 45 (degrees), the position attitude parameter for projecting a plurality of unit inspection regions in the three-dimensional model 3dm on the two-dimensional plane can be calculated for each imaging unit 421 of the remaining seven third imaging modules 42h. Thus, for example, for each imaging unit 421 of the eight third imaging modules 42h, an inspection image region in which a portion to be inspected is expected to be captured can be efficiently designated for a captured image that can be acquired by imaging of the inspection object W0.

### 2-5. Sixth Preferred Embodiment

In each of the above preferred embodiments, the matching processing is performed, but the present invention is not limited thereto. For example, when an error between the design position and attitude of each imaging unit 421 and the inspection object W0 and the actual position and attitude of each imaging unit 421 and the inspection object W0 in the inspection unit 40 is very small, the above-described matching processing may not be performed.

In this case, for example, based on the three-dimensional model information and the inspection region information acquired by the first acquisition unit 151 and the position attitude information acquired by the second acquisition unit 152, the designation unit 153 can create region designation information for designating the inspection image region corresponding to the inspection region for the captured image that can be acquired by the imaging of the inspection object W0 by the imaging unit 421.

Here, for example, for each imaging unit 421, the position and attitude of the three-dimensional model 3dm in the xyz coordinate system (three-dimensional model coordinate system) are transformed into the position and attitude in the x′y′z′ coordinate system (camera coordinate system) according to the position attitude parameters related to the position and attitude of the three-dimensional model 3dm in the x′y′z′ coordinate system (camera coordinate system), and then a plurality of unit inspection regions in the three-dimensional model 3dm are projected on a two-dimensional plane. Here, for example, by a method such as rendering, a plurality of unit inspection regions of the three-dimensional model 3dm is projected on a two-dimensional plane with the origin of the camera coordinate system as a reference point and the z′ axis direction of the camera coordinate system as an imaging direction. Here, for example, the imaging parameter information regarding each imaging unit 421 stored in the storage unit 14 or the like can be appropriately used. At this time, for example, hidden surface erasing processing of erasing a surface hidden by a portion existing on the front surface is performed, and a plurality of image regions on which a respective plurality of unit inspection regions are projected are set in a mutually distinguishable state. As the mutually distinguishable state, for example, a state can be considered in which different colors, hatching, or the like is designated for a plurality of image regions on which a respective plurality of unit inspection regions are projected. By such projection, for example, the region designation image Is1 is generated in which a plurality of inspection image regions are designated in which a respective plurality of portions to be inspected corresponding to a plurality of unit inspection regions are expected to be captured in a captured image that can be acquired when the imaging unit 421 images the inspection object W0.

When such a configuration is adopted, for example, in the designating step (step S3) in FIG. 14A, the processing of step S31 and step S33 shown in FIG. 14C is not performed, and in step S33, the region designation information for designating the inspection image region corresponding to the inspection region for the captured image that can be acquired by the imaging of the inspection object W0 by the imaging unit 421 has only to be created by the designation unit 153 based on the three-dimensional model information and the inspection region information acquired by the first acquisition unit 151 and the position attitude information. acquired by the second acquisition unit 152.

According to the image processing apparatus 100 and the image processing method according to the sixth preferred embodiment, for example, regarding the imaging unit 421, an inspection image region in which a portion to be inspected is expected to be captured can be efficiently designated for a captured image that can be acquired by imaging of the inspection object W0.

### 2-6. Other Preferred Embodiments

In each of the above preferred embodiments, for example, the first acquisition unit 151 does not need to perform the second region division processing of the first region division processing and the second region division processing described above. In other words, for example, the first acquisition unit 151 may be able to acquire the inspection region information by dividing the surface of the three-dimensional model 3dm into a plurality of regions based on the information regarding the orientations of a plurality of planes constituting the three-dimensional model 3dm. Even when such a configuration is adopted, for example, information regarding the inspection region can be easily acquired from the three-dimensional model information.

In each of the above preferred embodiments, for example, the first acquisition unit 151 acquires the inspection region information by dividing the surface of the three-dimensional model 3din into a plurality of regions (also referred to as unit inspection regions) based on the information related to the orientations of a plurality of planes constituting the three-dimensional model 3dm and the connection state of the planes in the plurality of planes, but the present invention is not limited thereto. For example, the first acquisition unit 151 may acquire the inspection region information related to the inspection region in the three-dimensional model 3dm prepared in advance. Here, for example, when the inspection region information is included in the various kinds of data 14d stored in the storage unit 14 or the like, the first acquisition unit 151 can acquire the inspection region information from the storage unit 14 or the like. In this case, for example, the first acquisition unit 151 does not need to perform both the first region division processing and the second region division processing described above.

In each of the above preferred embodiments, for example, the plurality of planes constituting the surface of the three-dimensional model 3dm having a shape in which the two cylinders are stacked as shown in FIG. 7A is divided into the upper surface region Ar1, the lower surface region Ar2, and the side surface region Ar3 as shown in FIG. 7B by the first region division processing performed by the first acquisition unit 151, but the present invention is not limited thereto. For example, a rule in which a plurality of planes in which the direction of the normal vector falls within a predetermined angle range (for example, 45 degrees) belong to one region in the cylindrical side surface region Ar3 may be added to the division rule of the first region division processing. In this case, for example, the side surface region Ar3 can be further divided into a plurality of regions (for example, eight regions).

In each of the above preferred embodiments, for example, as a predetermined division rule in the first region division processing performed by the first acquisition unit 151, a rule can be considered in which a plurality of planes in which directions of normal vectors of adjacent planes fall within a predetermined angle range belong to one region. Here, for example, when the three-dimensional model 3dm has a quadrangular pyramidal shape shown in FIG. 8A, as shown in FIG. 8C, a mode can be considered in which a plurality of planes constituting the surface of the quadrangular pyramidal three-dimensional model 3dm may be divided into a first slope region Ar9, a second slope region Ar10, a third slope region Ar11, a fourth slope region Ar12, and a lower surface region Ar13. When such a configuration is adopted, for example, the first acquisition unit 151 does not need to perform the second region division processing. In other words, for example, the first acquisition unit 151 may acquire the inspection region information by dividing the surface of the three-dimensional model 3dm into a plurality of regions based on information (normal vector or the like) related to orientations in a plurality of planes constituting the three-dimensional model 3dm. Even with such a configuration, for example, the information regarding the inspection region can be easily acquired from the information regarding the three-dimensional model 3dm.

In each of the above preferred embodiments, for example, the information for specifying the plurality of unit inspection regions obtained by dividing the surface of the three-dimensional model 3dm of the inspection object W0 is applied to the inspection region information, but the present invention is not limited thereto. For example, information for specifying one or more unit inspection regions for the surface of the three-dimensional model 3dm of the inspection object W0 may be applied to the inspection region information. In addition, to the inspection region information, for example, information for specifying one or more unit inspection regions for all surfaces of the three-dimensional model 3dm of the inspection object W0 may be applied, or information for specifying one or more unit inspection regions for some surfaces of the three-dimensional model 3dm of the inspection object W0 may be applied. In other words, for example, the set of the three-dimensional model information and the inspection region information may serve as information about the three-dimensional model 3dm in which one or more unit inspection regions are specified for at least a part of the surface.

In each of the above preferred embodiments, for example, the inspection unit 40 may include at least one imaging unit 421 among the plurality of imaging units 421 shown in FIGS. 3A and 38. In this case, the image processing in each of the above preferred embodiments may be performed on at least one imaging unit 421.

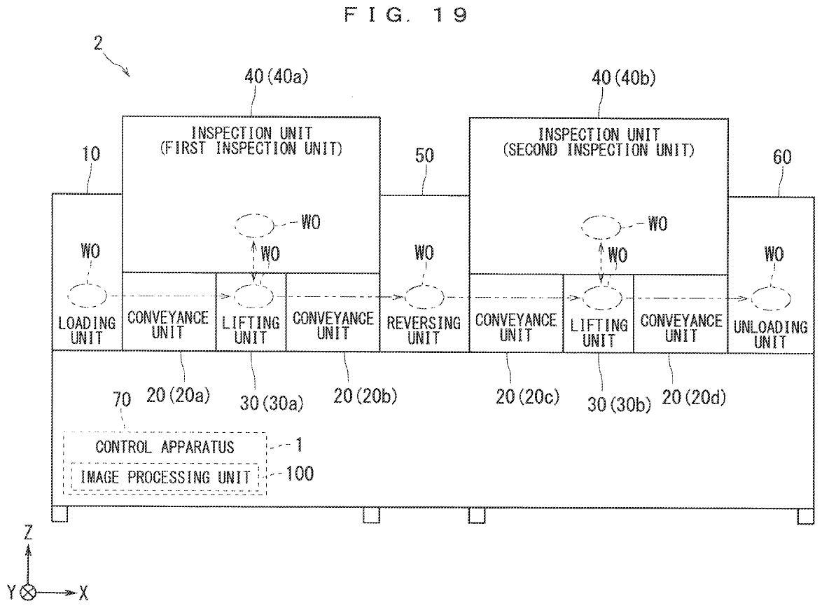

In each of the above preferred embodiments, for example, as shown in FIG. 19, the information processing apparatus 1 constitutes the control apparatus 70 of the inspection apparatus 2, and may function as an apparatus (image processing apparatus) 100 that performs various types of image processing in the inspection apparatus 2. Here, for example, it can be considered that the inspection apparatus 2 includes the image processing apparatus 100 as a portion (also referred to as an image processing unit) that performs image processing. In this case, in the inspection apparatus 2, for example, the inspection image region in which the portion to be inspected is expected to be captured can be efficiently designated with respect to the captured image that can be acquired by the imaging of the inspection object W0 with respect to the imaging unit 421.

In each of the above preferred embodiments, for example, the position attitude information acquired by the second acquisition unit 152 may include, for the imaging unit 421 of one or more positions and attitudes, information in the form of parameters indicating the position and attitude of the three-dimensional model 3dm in the x′y′z′ coordinate system (camera coordinate system) described above.

In each of the above preferred embodiments, for example, the imaging unit 421 may be capable of imaging not only the outer surface of the inspection object W0 but also the inner surface of the inspection object W0. For example, an imaging means using an ultrasonic wave or an electromagnetic wave such as an X-ray is applied to the imaging unit 421 that can also image the inner surface of the inspection object W0.

In the first to fifth preferred embodiments, the reference image Ir1 may be a captured image obtained by imaging the inspection object W0 by the imaging unit 421 for actual inspection, rather than an image obtained in advance by imaging by the imaging unit 421. For example, when a plurality of inspection objects W0 based on the same design are continuously inspected, the region designation information for designating the inspection image region may be created using the captured image obtained by imaging the first inspection object W0 by the imaging unit 421 as the reference image Ir1, and for the captured images obtained by imaging the second and subsequent inspection objects W0 by the imaging unit 421, the region designation information created at the time of inspection of the first inspection object W0 and the information such as the inspection condition for the inspection image region set at the time of inspection of the first inspection object W0 may be used.

In addition, in the first preferred embodiment, the automatic matching processing is performed. In the second preferred embodiment, the manual matching processing is performed. In the third preferred embodiment, the manual matching processing is performed, and then the automatic matching processing is further performed. However, the present invention is not limited thereto. For example, after the automatic matching processing is performed, the manual matching processing may be further performed. In this case, for example, after one model image is detected in step S33 by performing the processing similar to step S31 to step S33 related to the automatic matching processing of the first preferred embodiment, the processing similar to step S32b to step S35b related to the manual matching processing of the second preferred embodiment may be performed on the detected one model image. Here, for example, in steps S32b and S33b, one model image detected in step S33 is used instead of the first model image Im1. Thus, in step S32b, for example, the output unit 13 visibly outputs the first superimposition image Io1 obtained by superimposing the one model image detected in step S33 and the reference image Ir1. In addition, in step S33b, for example, the designation unit 153 sequentially generates a plurality of third model images Im3 in which the inspection object W0 is virtually captured by the imaging unit 421 while changing the position attitude parameter related to the position and attitude of the three-dimensional model 3dm with reference to the parameter (second position attitude parameter) related to the position and attitude of the three-dimensional model 3dm used to generate one model image detected in step S33 according to the information accepted by the input unit 12 in response to the action of the user. At this time, for example, every time each of the plurality of third model images Im3 is newly generated, the second superimposition image Io2 in which the reference image Ir1 and the newly generated third model image Im3 are superimposed is visibly output by the output unit 13. Then, in steps S34b and S35b, for example, in response to the information accepted by the input unit 12 in response to the specific action by the user, the region designation information for designating the inspection image region for the captured image is created by the designation unit 153 based on the position attitude parameter regarding the position and attitude of the three-dimensional model 3dm used to generate one third model image Im3 superimposed on the reference image Ir1 when generating the second superimposition image Io2 visibly output by the output unit 13 among the plurality of third model images Im3, the three-dimensional model information, and the inspection region information. When such a configuration is adopted, for example, for each imaging unit 421, when the reduction of the deviation caused between the portion corresponding to the three-dimensional model 3dm in the first model image Im1 which is generated based on the design three-dimensional model information and the design position attitude information and in which the imaging unit 421 virtually captures the three-dimensional model 3dm and the portion corresponding to the inspection object W0 in the reference image Ir1 obtained by the imaging of the inspection object W0 by the imaging unit 421 is insufficient by the automatic correction by the automatic matching processing, the deviation can be reduced by the manual correction by the further manual matching processing. Thus, for example, an inspection image region in which a portion to be inspected is expected to be captured can be efficiently designated for a captured image that can be acquired by imaging of the inspection object W0. Such a configuration is considered to be effective, for example, when the holding unit 41 and the inspection object W0 overlap in the reference image Ir1 and the correction by the automatic matching processing cannot be sufficiently performed.

It should be noted that it goes without saying that all or part of components constituting each of the above preferred embodiments and its various modifications can be combined in an appropriate and consistent scope.

While the invention has been shown and described in detail, the foregoing description is in all aspects illustrative and not restrictive. it is therefore understood that numerous modifications and variations can be devised without departing from the scope of the invention.

What is claimed is:

1. An image processing apparatus comprising:
a first acquisition unit configured to acquire three-dimensional model information related to a three-dimensional model of an inspection object and inspection region information related to an inspection region in the three-dimensional model;
a second acquisition unit configured to acquire position attitude information regarding a position and an attitude of an imaging unit and said inspection object in an inspection apparatus; and
a designation unit configured to create region designation information for designating an inspection image region corresponding to said inspection region for a captured image that can be acquired by imaging of said inspection object by said imaging unit, based on said three-dimensional model information, said inspection region information, and said position attitude information.

2. The image processing apparatus according to claim 1, wherein said first acquisition unit is configured to acquire said inspection region information by dividing a surface of said three-dimensional model into a plurality of regions based on information related to orientations of a plurality of planes constituting said three-dimensional model.

3. The image processing apparatus according to claim 2, wherein said first acquisition unit is configured to acquire said inspection region information by dividing a surface of said three-dimensional model into said plurality of regions based on information related to orientations of said plurality of planes constituting said three-dimensional model and a connection state of planes in said plurality of planes.

4. The image processing apparatus according to claim 1, wherein said designation unit is configured to
generate a first model image obtained by virtually capturing said inspection object by said imaging unit based on said three-dimensional model information and said position attitude information,
generate each of a plurality of second model images obtained by virtually capturing said inspection object by said imaging unit while changing a position attitude parameter related to a position and an attitude of said three-dimensional model by a predetermined rule with reference to a first position attitude parameter used to generate said first model image,
detect one model image of said first model image and said plurality of second model images according to a matching degree between a portion corresponding to said three-dimensional model in each of said first model image and said plurality of second model images and a portion corresponding to said inspection object in a reference image obtained by imaging said inspection object by said imaging unit, and
create said region designation information for said captured image based on said position attitude parameter used to generate the one model image, said three-dimensional model information, and said inspection region information.

5. The image processing apparatus according to claim 1, further comprising:
an output unit configured to visibly output information; and
an input unit configured to accept input of information in response to an action of a user,
wherein said designation unit is configured to generate a first model image obtained by virtually capturing said inspection object by said imaging unit based on said three-dimensional model information and said position attitude information,
wherein said output unit is configured to visibly output a first superimposition image in which a reference image obtained by imaging of said inspection object by said imaging unit and said first model image are superimposed,
wherein said designation unit is configured to sequentially generate a plurality of second model images obtained by virtually capturing said inspection object by said imaging unit while changing a position attitude parameter related to a position and an attitude of said three-dimensional model with reference to a first position attitude parameter used to generate said first model image according to information accepted by said input unit in response to an action of said user,
wherein said output unit is configured to visibly output a second superimposition image obtained by superimposing said reference image and the second model image newly generated each time each of said plurality of second model images is newly generated by said designation unit, and
wherein in response to information accepted by said input unit in response to a specific action of said user, said designation unit creates said region designation information for said captured image based on said position attitude parameter used to generate one second model image superimposed on said reference image when generating said second superimposition image visibly output by said output unit among said plurality of second model images, said three-dimensional model information, and said inspection region information.

6. The image processing apparatus according to claim 1, further comprising:
an output unit configured to visibly output information; and
an input unit configured to accept input of information in response to an action of a user,
wherein said designation unit is configured to generate a first model image obtained by virtually capturing said inspection object by said imaging unit based on said three-dimensional model information and said position attitude information,
wherein said output unit is configured to visibly output a first superimposition image in which a reference image obtained by imaging of said inspection object by said imaging unit and said first model image are superimposed,
wherein said designation unit is configured to sequentially generate a plurality of second model images obtained by virtually capturing said inspection object by said imaging unit while changing a position attitude parameter related to a position and an attitude of said three-dimensional model with reference to a first position attitude parameter used to generate said first model image according to information accepted by said input unit in response to an action of said user,
wherein said output unit is configured to visibly output a second superimposition image obtained by superimposing said reference image and the second model image newly generated each time each of said plurality of second model images is newly generated by said designation unit, and
wherein in response to information accepted by said input unit in response to a specific action of said user, said designation unit generates each of a plurality of third model images obtained by virtually capturing said inspection object by said imaging unit while changing a position attitude parameter related to a position and an attitude of said three-dimensional model by a predetermined rule with reference to a second position attitude parameter used for generating one second model image superimposed on said reference image when generating said second superimposition image visibly output by said output unit among said plurality of second model images, detects one model image of said one second model image and said plurality of third model images according to a matching degree between a portion corresponding to said three-dimensional model in each of said one second model image and said plurality of third model images and a portion corresponding to said inspection object in a reference image obtained by imaging said inspection object by said imaging unit, and creates said region designation information for said captured image based on said position attitude parameter used to generate the one model image, said three-dimensional model information, and said inspection region information.

7. The image processing apparatus according to claim 1, further comprising:
an output unit configured to visibly output information; and
an input unit configured to accept input of information in response to an action of a user,
wherein said designation unit is configured to
generate a first model image obtained by virtually capturing said inspection object by said imaging unit based on said three-dimensional model information and said position attitude information,
generate each of a plurality of second model images obtained by virtually capturing said inspection object by said imaging unit while changing a position attitude parameter related to a position and an attitude of said three-dimensional model by a predetermined rule with reference to a first position attitude parameter used to generate said first model image, and
detect one model image of said first model image and said plurality of second model images according to a matching degree between a portion corresponding to said three-dimensional model in each of said first model image and said plurality of second model images and a portion corresponding to said inspection object in a reference image obtained by imaging said inspection object by said imaging unit,
wherein said output unit is configured to visibly output a first superimposition image obtained by superimposing said one model image and said reference image,
wherein said designation unit is configured to sequentially generate a plurality of third model images obtained by virtually capturing said inspection object by said imaging unit while changing a position attitude parameter related to a position and an attitude of said three-dimensional model with reference to a second position attitude parameter used to generate said one model image according to information accepted by said input unit in response to an action of said user,
wherein said output unit is configured to visibly output a second superimposition image obtained by superimposing said reference image and the third model image newly generated, each time each of said plurality of third model images is newly generated by said designation unit, and
wherein in response to information accepted by said input unit in response to a specific action of said user, said designation unit creates said region designation information for said captured image based on said position attitude parameter used to generate one third model image superimposed on said reference image when generating said second superimposition image visibly output by said output unit among said plurality of third model images, said three-dimensional model information, and said inspection region information.

8. The image processing apparatus according to claim 1, further comprising:
an output unit configured to visibly output information,
an input unit configured to accept input of information in response to an action of a user, and
a setting unit configured to set an inspection condition for said inspection image region according to information accepted by said input unit in response to an action of said user in a state where information related to said inspection image region designated by said region designation information is visibly output by said output unit.

9. An inspection apparatus configured to inspect an inspection object having a three-dimensional shape, the inspection apparatus comprising:
a holding unit configured to hold said inspection object;
an imaging unit configured to image said inspection object held by the holding unit; and
an image processing unit,
wherein said image processing unit includes:
a first acquisition unit configured to acquire three-dimensional model information related to a three-dimensional model of said inspection object and inspection region information related to an inspection region in the three-dimensional model,
a second acquisition unit configured to acquire position attitude information regarding a position and an attitude of said imaging unit and said inspection object held by said holding unit, and
a designation unit configured to create region designation information for designating an inspection image region corresponding to said inspection region for a captured image that can be acquired by imaging of said inspection object by said imaging unit, based on said three-dimensional model information, said inspection region information, and said position attitude information.

10. An image processing method comprising:
(a) acquiring three-dimensional model information related to a three-dimensional model of an inspection object and inspection region information related to an inspection region in the three-dimensional model by a first acquisition unit;
(b) acquiring position attitude information regarding a position and an attitude of an imaging unit and said inspection object in an inspection apparatus by a second acquisition unit; and
(c) creating region designation information for designating an inspection image region corresponding to said inspection region for a captured image that can be acquired by imaging of said inspection object by said imaging unit, based on said three-dimensional model information, said inspection region information, and said position attitude information by a designation unit.

11. A non-transitory computer readable recording medium storing a program, said program causing a processor of a control unit in an information processing apparatus to execute:
(a) acquiring three-dimensional model information related to a three-dimensional model of an inspection object and inspection region information related to an inspection region in the three-dimensional model by a first acquisition unit;
(b) acquiring position attitude information regarding a position and an attitude of an imaging unit and said inspection object in an inspection apparatus by a second acquisition unit; and
(c) creating region designation information for designating an inspection image region corresponding to said inspection region for a captured image that can be acquired by imaging of said inspection object by said imaging unit, based on said three-dimensional model information, said inspection region information, and said position attitude information by a designation unit.
